(19) United States
(12) Patent Application Publication
(10) Pub. No.: US 2024/0238774 A1
(43) Pub. Date: Jul. 18, 2024

(54) TWO COMPONENT ION EXCHANGE RESINS

(71) Applicant: ION EXCHANGE (INDIA) LIMITED, Mumbai Maharashtra (IN)

(72) Inventors: Prabhakar Rajaram PARAB, Ratnaagiri-Maharashtra (IN); Kotte Madhusudhana RAO, Kukatpally Hyderabad - Telangana (IN); Pramod M. KULKARNI, Hyderabad-Telangana (IN); Natarajan ANBANANTHAN, Chennai-Tamilnadu (IN); Prabhakar PATAKOTLA, Hyderabad-Telangana (IN); Nagendra AVULA, Patancheru - Sangareddy Dist., Telangana (IN)

(21) Appl. No.: 18/289,504

(22) PCT Filed: May 20, 2022
(86) PCT No.: PCT/IN2022/050476

§ 371 Date: Nov. 3, 2023

(30) Foreign Application Priority Data
Jul. 20, 2021 (IN) 202121032514

(51) Int. Cl. B01J 39/05; B01J 39/07; B01J 39/19; B01J 41/05; B01J 41/14; C08F 112/08; C08L 25/06

(52) U.S. Cl. CPC B01J 39/05; B01J 39/07; B01J 39/19; B01J 41/05; B01J 41/14; C08F 112/08; C08L 25/06; C08L 2205/025

(57) ABSTRACT

The present invention discloses two component cross-linked copolymers in bead form wherein the cross-linked copolymer of the first component formed in the first step has lower cross-linker content than the cross-linker content in the cross-linked copolymer of the second component formed in the second step. These beads are further functionalized to yield strong acid cation exchange resins, strong base anion exchange resins and weak acid cation exchange resins. Ion exchange resins so synthesized exhibit operating exchange capacity (OEC) to total exchange capacity (TEC) ratio in the range of 49 to 61% and also retain more than 85% of whole bead count when subject to osmotic shock resistance test to simulate performance in usage. These ion exchange resins offer advantages in applications such as water treatment, condensate polishing, and unit operations in non-water application like drug purification, sugar processing, catalysis etc.

### 1. FIELD OF THE INVENTION

The present invention relates to ion exchange resins. More particularly it relates to two component cross-linked copolymers in bead form and strong acid cation, strong base anion, and weak acid cation exchange resins derived there from which find uses in water and non-water applications like drug purification, sugar processing and catalysis etc.

### 2. BACKGROUND OF THE INVENTION

Ion exchange resins are solid matrices which carry exchangeable ions. The resins based on their composition may be classified as strong acid cation, weak acid cation, strong base anion, weak base anion and amphoteric resins. These resins find applications in diverse industrial fields such as water treatment and purification, in pharmaceutical industry, in the separation and purification of amino acids, antibiotics, vitamins and hormones, in sugar processing, in the recovery of organic acids such as citric, ascorbic and tartaric acids. They are also used as catalysts in a wide range of chemical reactions, notably esterification and trans-esterification.

The ion exchange resins are generally prepared in two steps. In the first step the cross-linked polymer bead is prepared by the suspension polymerization technique. The suspension polymerization techniques have been adequately described in “Polymer Processes”, edited by Calvin E. Schildknecht, published in 1956 by Interscience Publishers, Inc., New York, Chapter III, “Polymerization in Suspension” by E. Trommsdoff and C. E. Schildknecht, wherein are listed various monomers which can be used in the preparation of polymer beads. Suspension polymerization for the synthesis of ion exchange resins has been in particularly described in U.S. Pat. No. 4,224,415. It is well known that the thermal and mechanical properties of the ion exchange resins are primarily governed by the composition and properties of the cross-linked polymer beads prepared in the first step. These beads are subsequently functionalized to yield either 1) strong acid cation, 2) weak acid cation, 3) strong base anion, 4) weak base anion or 5) amphoteric resins. The functionalization techniques used to obtain the ion exchange resins from the cross-linked polymer beads are well-known in the art and have been described in various US patents. Methods of synthesis of strong acid cation exchange (SAC) resins are described in U.S. Pat. Nos. 2,500,149; 2,631,127; 2,664,801; 2,764,564 and 3,266,007 which describe sulfonating reagents and reaction conditions. Methods of synthesis of strong base anion exchange (SBA) resins are described in U.S. Pat. Nos. 2,597,492; 2,597,493; 2,616,817; 2,642,417; 2,960,480 and 3,311,602 which describe halo alkylating agents and conditions. U.S. Pat. Nos. 2,616,877; 2,642,417; 2,632,000; 2,632,001 and 2,992,544 describe aminating agents and aminating conditions. All of these are incorporated herein fully by way of reference.

The performance of the ion exchange resins during a given application depends upon the composition, morphology and properties of the cross-linked polymer beads prepared in the first step and the type and extent of functionalization carried out during the second step, which determines its total exchange capacity (TEC).

Ion exchange is a diffusion-controlled process, more particularly under typical operating conditions it is controlled by pore diffusion rather than by film diffusion (See “Ion Exchange,” F. Helfferich, McGraw-Hill Book Co. Inc., 1962). As a result, the ion exchange sites buried within the resin bead are not readily accessible and the time for these sites to affect ion exchange is uneconomically long for many applications. During regeneration this often leads to long regeneration times, large regenerant volume requirements, and ionic leakage. For the same reason such resins have to be regenerated when only a fraction of their TEC has been utilised. Thus, useful operating exchange capacity (OEC) of these resins to remove ions from a medium is lower than their TEC. Regeneration of the ion exchange resins also leads to significant volume changes dueto ionic concentration variation, which generates swelling induced stresses, resulting in attrition of ion exchange beads causing reduction in the efficiency of the ion exchange column and concomitantly the servicing costs incurred in replacing the damaged resin beads.

Early attempts made to bring about uniform sulfonation and overcome swelling induced breakage of ion exchange resins involved sulfonation of resin beads in the presence of swelling solvents such as nitrobenzene. In efforts to eliminate the use of solvents during sulfonation, U.S. Pat. No. 4,500,652 claimed suspension polymerization of styrene and divinylbenzene (DVB) in presence of monomers such as acrylic acid, methacrylic acid and their lower alkyl esters.

An early solution to overcome the diffusional limitations in these gel type or microporous resins was the use of macroporous or macroreticular resins. However, these resins suffered from lower exchange capacities and poor mechanical properties.

One of the earliest solutions to this problem was to develop core shell graft copolymers as described in U.S. Pat. Nos. 3,489,699 and 3,565,833 wherein a copolymer grafted on an inert core, formed a shell which was suitably functionalized to impart ion exchange characteristics.

U.S. Pat. No. 4,419,245 described a process for the synthesis of cross-linked ion exchange copolymer particles wherein the seed particles were swollen by feeding monomer and cross-linker mixture in the form of an aqueous emulsion and further polymerized. Amongst advantages of using an emulsion were cited 1) control of distribution of feed,
1. improved physical contact between feed and seed, and 3) improved kinetics of swelling of beads. The feed to seed ratio was typically 4, although a broader range of 2 to 20, was cited. The seed contained generally 0.1% to 3%, preferably 0.1% to 1.5%, and even more preferably 0.1% to 1% by weight of divinylbenzene (DVB). The seeds were to be prepared in the absence of protective colloids as they prevented seed from imbibing the monomer feed during polymerization. The monomer and cross-linker mixture was fed to the seed as an aqueous medium along with an emulsifier. The addition of protective colloid was also to be avoided immediately after the feeding of the monomer and cross-linker mixture as to avoid the creation of new population of droplets which would lead to fines. The cross-linked copolymer beads formed were characterized by a two-stage swelling separated by a plateau. The copolymer beads and ion exchange resins obtained there from offered 1) good mechanical strength, 2) resistance to osmotic stresses 3) resistance to external forces and 4) high fluid flow capability, which was attributed to the core shell morphology of the cross-linked copolymer bead.

In an effort to develop ion exchange resins which exhibit improved osmotic shock resistance and mechanical properties, U.S. Pat. Nos. 4,564,644 and 5,068,255 described a process comprising (a) forming a suspension of cross-linked free radical containing polymeric matrices in a continuous phase, and (b) contacting the same with a monomer feed comprising a monomer or monomer/cross-linker mixture which imbibed polymeric matrices of stage (a), such that the polymerization of the fed mixture was initiated by the radicals on the polymer matrix. To ensure that the polymerization of the monomers in the monomer feed was initiated by the free radicals located on the polymeric matrix, no initiators were added either to the monomer feed or the continuous phase in the second stage. The copolymer beads formed exhibited core/shell morphology such that the degree of cross-linking in the shell was lower than that in the core. The copolymer beads were subsequently converted to ion exchange resins, which also exhibited core shell morphology. The ion exchange resins exhibited resistance to osmotic shocks as well as good mechanical strength. Applications of these resins in the purification of power plant condensate was described in U.S. Pat. No. 4,975,201. Copolymer beads bearing core/shell morphology were used for the removal of the alkaline earth metal and transition metal ions by incorporating (aminomethyl) (hydroxymethyl) phosphinic acid groups. In an attempt to enhance the kinetics of exchange, U.S. Pat. No. 5,141,965 described cross-linked copolymer beads wherein weak-base exchange functionalities were substituted at haloalkylated sites most readily accessible to diffusion. Strong base anion exchange functionalities were substituted at sites least accessible to diffusion. The hydrophilicity imparted by the later, improved overall exchange kinetics. Applications of partially sulfonated ion exchange resins in sugar chromatography were described in EP 0,361,685.

The need to develop cross-linked copolymer beads containing core shell morphology bearing even higher crosslink densities in the core as well as in the shell than those described in U.S. Pat. No. 5,278,193 was recognized and synthesis of such beads and ion exchange resins derived there from was described in U.S. Pat. No. 8,686,055.

### 1. SUMMARY OF THE INVENTION

Surprisingly it has been found that the ion exchange resins derived from the two component cross-linked copolymers in bead form, wherein the cross-linked copolymer of the first component has lower cross-linker content than the cross-linker content in the cross-linked copolymer of the second component, exhibit an OEC/TEC ratio in the range of 49% to 61%.

According to an embodiment of the present invention the weight ratio of the cross-linked copolymer of the first component to that of the cross-linked copolymer of the second component in the two component cross-linked copolymer in the bead form is in the range of 1:1.2 to 1:2.7.

According to an embodiment of the present invention the two component cross-linked copolymers in the bead form do not exhibit core shell morphology prior to functionalization. According to an embodiment of the present invention the two component cross-linked copolymers in the bead form exhibit one stage swelling in toluene wherein 100% swelling is achieved in 0.75 hrs to 24.0 hrs.

According to an embodiment of the present invention the monovinyl monomer for the synthesis of the cross-linked copolymer of the first component is selected from styrene, methyl methacrylate (MMA), methyl acrylate and methacrylic acid.

According to an embodiment of the present invention the monovinyl monomer for the synthesis of the cross-linked copolymer of the second component is selected from styrene, MMA, methyl acrylate, methacrylic acid and hydroxyl ethyl methacrylate (HEMA).

According to an embodiment of the present invention the cross-linker content of the cross-linked copolymer of the first component varies in the range of 1.8 to 3% w/w.

According to an embodiment of the present invention the cross-linker content of the cross-linked copolymer of the second component varies in the range of 2 to 9% w/w.

According to an embodiment of the present invention the cross-linker for the cross-linked copolymer of the first component is selected from DVB, ethylene glycol dimethacrylate (EGDMA), 1, 7-octadiene and trivinyl cyclohexane (TVCH).

According to an embodiment of the present invention the cross-linker for the cross-linked copolymer of the second component is selected from DVB, EGDMA, 1, 7-octadiene and TVCH. According to an embodiment of the present invention the cross-linked copolymer of the first component is prepared by suspension copolymerization in the presence of a protective colloid.

According to an embodiment of the present invention the cross-linked copolymer of the second component is prepared by suspension copolymerization in the presence of a protective colloid.

According to an embodiment of the present invention the monomer composition of the cross-linked copolymer of the second component is imbibed in the cross-linked copolymer composition of the first component prior to the copolymerization of the monomer composition of the cross-linked copolymer of the second component.

According to an embodiment of the present invention the copolymerization of the monomer composition of the cross-linked copolymer of the first component is completed before the monomer composition of the cross-linked copolymer of the second component is imbibed in the cross-linked copolymer composition of the first component.

According to an embodiment of the present invention the monomer composition of the cross-linked copolymer of the first component as well as the monomer composition of the cross-linked copolymer of the second component always contains a free radical initiator.

According to an embodiment of the present invention the free radical initiator for the monomer composition of the first component is selected from benzoyl peroxide (BPO), dicumyl peroxide (DCP) and azobisisobutyronitrile (AIBN).

According to an embodiment of the present invention the free radical initiator for the monomer composition of the cross-linked copolymer of the second component is selected from BPO, DCP and AIBN.

According to an embodiment of the present invention the free radical initiator for the monomer composition of the cross-linked copolymer of the first component and the free radical initiator of the monomer composition of the cross-linked copolymer of the second component is the same.

According to an embodiment of the present invention the free radical initiator for the monomer composition of the cross-linked copolymer of the first component and the free radical initiator of the monomer composition of the cross-linked copolymer of the second component are different.

According to an embodiment of the present invention the free radical initiator for the monomer composition of the cross-linked copolymer of the second component contains more than one initiator.

According to an embodiment of the present invention, the ion exchange resin derived from the two component cross-linked copolymer beads exhibits core shell morphology. According to an embodiment of the present invention, the ion exchange resin derived from the two component cross-linked copolymer beads does not exhibit core shell morphology.

According to an embodiment of the present invention the ion exchange resin derived from the two component cross-linked copolymers, is a strong acid cation exchange resin.

According to an embodiment of the present invention the strong acid cation exchange resin is synthesized using a weight ratio of two component cross-linked styrene—DVB copolymers in the bead form to sulfuric acid in the range of 1:3.6 to 1:7.2 w/w.

According to an embodiment of the present invention the sulfonation reaction is carried out using sulfuric acid concentration in the range of 93 to 100% w/w.

According to an embodiment of the present invention the strong acid cation exchange resin derived from the two component cross-linked copolymers in the bead form exhibits an OEC/TEC ratio in the range of 49% to 61%.

According to an embodiment of the present invention the strong acid cation exchange resin has TEC in the wet form in the range of 1.25 to 1.85 equivalents per litre (eq/L). According to an embodiment of the present invention the strong acid cation exchange resin has a crushing strength in the range of 500 to 1000 grams per bead (g/bead).

According to an embodiment of the present invention the strong acid cation exchange resin of the present invention when subjected to osmotic shock resistance test retains a whole bead count greater than 80%.

According to an embodiment of the present invention the strong acid cation exchange resin of the present invention exhibits one or more of the following advantages during regeneration a) better quality of treated water (i.e. low levels of ionic impurities as compared to the water treated with conventional strong acid cation resins under identical operating conditions) at lower regeneration level, b) higher regeneration efficiencies than those for conventional resins and c) lower water requirement for washing of resin after regeneration (water saving or less effluent).

According to an embodiment of the present invention the strong acid cation exchange resin of the present invention exhibits advantages in one or more of the following applications such as water treatment, condensate polishing unit, operations in non-water applications like drug purification, sugar processing and catalysis etc.

According to an embodiment of the present invention the ion exchange resin derived from the two component cross-linked copolymers, is a strong base anion exchange resin.

According to an embodiment of the present invention the strong base anion exchange resin derived from the two component cross-linked copolymers in the bead form exhibits an OEC/TEC ratio in the range of 55% to 57%.

According to an embodiment of the present invention the strong base anion exchange resin is obtained by chloromethylation of the two component cross-linked copolymer beads followed by amination.

According to an embodiment of the present invention the chloromethylation of the two component cross-linked copolymer beads is carried out using reagents selected from chloro methyl methyl ether (CMME), dimethoxy methane, methanol-formaldehyde solution (MF solution) and chlorosulfonic acid (CSA).

According to an embodiment of the present invention the amination of chloromethylated two component cross-linked copolymers in the bead form is carried out using aliphatic amines selected from dimethyl ethanolamine, trimethylamine and triethylamine.

According to an embodiment of the present invention the strong base anion exchange resin is synthesized using a weight ratio of two component cross-linked styrene—DVB copolymers in the bead form to chloromethylating agent in the range of 0.93 to 2.25 w/w.

According to an embodiment of the present invention the strong base anion exchange resin has TEC in the wet form in the range of 0.74 to 1.02 eq/L.

According to an embodiment of the present invention, the strong base anion exchange resin exhibits core shell morphology.

According to an embodiment of the present invention, the strong base anion exchange resin does not exhibit core shell morphology.

According to an embodiment of the present invention the strong base anion exchange resin has a crushing strength in the range of 300 to 600 g/bead.

According to an embodiment of the present invention, the strong base anion exchange resin when subjected to osmotic shock resistance test retains a whole bead count greater than 80%.

According to an embodiment of the present invention strong base anion exchange resin of the present invention exhibits one or more of the following advantages during regeneration, a) better quality of treated water at lower regeneration level b) higher regeneration efficiencies than those for conventional resins and c) lower water requirement for washing of resin after regeneration (water saving or less effluent).

According to an embodiment of the present invention the strong base anion exchange resin exhibits advantages in one or more of the following applications such as water treatment, preparation of ultrapure water, condensate polishing, catalysis and sugar processing etc.

According to an embodiment of the present invention the ion exchange resin derived from the two component cross-linked copolymers, is a weak acid cation exchange (WAC) resin.

According to an embodiment of the present invention the weak acid cation exchange resin exhibits an OEC/TEC ratio in the range of 49% to 60%.

According to an embodiment of the present invention the weak acid cation exchange resin has a TEC in the range of 1.95 to2.76 eq/L.

According to an embodiment of the present invention the weak acid cation exchange resin does exhibit core shell morphology.

According to an embodiment of the present invention the weak acid cation exchange resin does not exhibit core shell morphology.

According to an embodiment of the present invention the weak acid cation exchange resin of the present invention exhibits advantages in one or more of the following applications, like drug purification, water treatment and other process applications.

According to an embodiment of the present invention a wide range of ion exchange resins varying in TEC, OEC/TEC ratio, moisture content and whole bead count can be prepared by varying the composition of the cross-linked copolymer of the first component formed in the first step, the composition of the cross-linked copolymer of the second component formed in the second step, the weight ratio of cross-linked copolymer of the first component formed in the first step to the cross-linked copolymer of the second component formed in the second step and functionalization conditions.

### 2. BRIEF DESCRIPTION OF THE DRAWINGS

FIG. 1: Swelling behaviour of two component crosslinked polymer beads in toluene; 1. Example 1; 2) Example 14; 3) Example 16; 4) Example 15

FIG. 2: Experimental set up for performance evaluation of ion exchange resins

FIG. 3: X ray microtomography images of 1) cross-linked copolymer bead of Example 1; 2) strong acid cation exchange resin bead of Example 27; 3) strong acid cation exchange resin bead of Example 40; 4) strong base anion exchange resin bead of Example 52; 5) weak acid cation exchange resin bead of Example 53.

### 1. DETAILED DESCRIPTION OF THE INVENTION

The synthesis of ion exchange resins involves the synthesis of cross-linked polymer beads by suspension polymerization technique, which is then appropriately functionalized to obtain strong acid cation exchange resins, strong base anion exchange resins, and weak acid cation exchange resins. The present invention involves synthesis of two component cross-linked copolymers in the bead form wherein the cross-linked copolymer of the first component formed in the first step has lower cross-linker content than the cross-linker content in the cross-linked copolymer of the second component incorporated in the second step, by suspension polymerization technique using protective colloids in each step.

The monomer compositions used in the synthesis of cross-linked copolymers of the first component in the bead form formed in the first step prepared by suspension polymerization using protective colloids have cross-linker content in the range of 1.8% to 3% w/w. These beads exhibit a limited swelling capacity in the range of 1:1.2 to 1:2.64 when swollen by the monomer composition constituting cross-linked copolymer of the second component, which have cross-linker content in the range of 2% to 9% w/w. Further the monomer composition constituting cross-linked copolymer of the second component is absorbed in to the beads of the cross-linked copolymer of the first component before the polymerization of monomer composition constituting cross-linked copolymer of the second component is initiated. The polymerization of monomer composition constituting cross-linked copolymer of the second component is initiated by the initiator incorporated in the monomer composition. The two component cross-linked copolymers in the bead form so synthesized do not exhibit core shell morphology. The beads so formed show single stage swelling behaviour in toluene, and complete swelling is achieved in about twenty-four hours. These beads are further functionalized to yield strong acid cation exchange resins, strong base anion exchange resins and weak acid cation exchange resins. Depending upon the functionalization conditions employed, the ion exchange resins formed may or may not exhibit core shell morphology. Ion exchange resins so synthesized exhibit OEC to TEC ratio in the range of 49 to 61% and also retain more than 80% of whole bead count when subject to osmotic shock resistance test to simulate performance in repeated usage. A wide range of ion exchange resins varying in TEC, OEC/TEC ratio, bearing good mechanical strength as reflected in the Chatillon test and osmotic shock resistance can be prepared by the choice of the composition of the two component cross-linked copolymers in the bead form and functionalization conditions. These two component resins offer advantages in water treatment viz. water softening and demineralization, condensate polishing, and in non-water applications like drug purification, sugar processing and catalysis etc.

The invention is now illustrated by the examples below, which are representative only and by no means limit the scope of the invention.

### EXAMPLES

### Synthesis of Two Component Cross-Linked Copolymers in the Bead Form

### Example 1

To a one litre, four-neck reaction kettle equipped with a stirrer, a thermocouple probe, a water bath, a temperature controller and a condenser, 200 g of water was added, followed by 0.3 g of hydroxy propyl methyl cellulose (HPMC) [Grade—viscosity of 2% aqueous solution at 25° C. is about 400-450 centipoises (cPs)] and 1 g of disodium phosphate (DSP). The agitator speed was set at 200-300 revolutions per minute (rpm) after which the contents were heated to 75° C. over a period of 20 to 30 minutes then agitator speed was adjusted to 60 to 70 rpm. After 15 minutes, the first monomer feed containing 94.73 g of styrene and 5.27 g of commercially available technical grade DVB solution containing 3 g of DVB and 0.4 g of BPO was added. The temperature was maintained at 75° C. A sticky copolymer mass was formed after 45 minutes. At this stage the agitator speed was increased in the range of 100 to 120 rpm, to avoid agglomeration of reaction mass, and polymerization was continued for 3 hours. Then polymerization temperature was raised to 85° C. continued for 3 hours and then at 95° C. for 3 hours. The content of the reaction kettle was cooled to room temperature and then aqueous portion (˜180 mL) was siphoned out. The second monomer feed containing 147.63 g of styrene and 17.37 g of commercially available technical grade DVB solution containing 9.9 g of DVB and 0.66 g of BPO was added to the cross-linked copolymer beads of the first component. Then, monomer composition of the cross-linked copolymer of the second component was allowed to imbibe in the cross-linked copolymer beads of first component over a period of 2 hours. Then fresh aqueous phase consists of 540 mL of water, 0.81 g of HPMC and 2.7 g of DSP was charged to the kettle. The polymerization reaction was continued under stirring (100 to 120 rpm) at 75° C. for 3 hours and then at 85° C. for 3 hours and further at 95° C. for 3 hours. The content of the reaction kettle was then cooled to room temperature and beads of two component cross-linked copolymer were filtered and washed until water washings showed no foaming. The product was dried in an oven at 100° C. for 8 hours. The yield of the two component cross-linked copolymer beads based on total monomer charge was greater than 95%.

### Example 2

The experiment was conducted as described in Example 1, except that the monomer composition of the cross-linked copolymer of the second component did not contain BPO. It was found that, the two component cross-linked copolymers beads obtained were sticky, had styrene smell and the yield was 65%, which indicates second component monomer conversion to polymer was incomplete.

### Example 3

The experiment was conducted as described in Example 1, except that the monomer composition of the cross-linked copolymer of the second component contained 0.165 g of BPO. The yield of the two component cross-linked copolymer beads was greater than 95%.

### Example 4

The experiment was conducted as described in Example 1, except that the monomer composition of the cross-linked copolymer of the second component contained 0.33 g of BPO. The yield of the two component cross-linked copolymer beads was greater than 95%.

### Example 5

The experiment was conducted as described in Example 1, except that the monomer composition of the cross-linked copolymer of the second component contained 1.00 g of BPO. The yield of the two component cross-linked copolymer beads was greater than 95%.

### Example 6

The experiment was conducted as described in Example 1, except that the monomer composition of the cross-linked copolymer of the second component contained 1.32 g of BPO. The yield of the two component cross-linked copolymer beads was greater than 95%.

### Example 7

The experiment was conducted as described in Example 1, except that monomer composition of the cross-linked copolymer of the second component contained 1.65 g of BPO. The yield of the two component cross-linked copolymer beads was greater than 95%.

### Example 8

To a one litre, four-neck reaction kettle equipped with an agitator, a thermocouple probe, a water bath, a temperature controller and a condenser, 200 g of water was added, followed by 0.3 g of hydroxy propyl ethyl cellulose (HPEC) (Grade—viscosity of 1% aq. solution at 25° C. is about 300 cPs) and 1 g of DSP. The agitator speed was set between 200 and 300 rpm after which the contents were heated to 75° C. over a period of 20 to 30 minutes then agitator speed was adjusted to 60 to 70 rpm. After 15 minutes, the first monomer feed containing 94.73 g of styrene and 5.27 g of commercially available technical grade DVB solution containing 3 g of DVB and 0.4 g of BPO was added. The temperature was maintained at 75° C., a sticky copolymer mass was formed after 45 minutes. At this stage the agitator speed was increased in the range of 100 to 120 rpm, to avoid agglomeration of reaction mass, and polymerization was continued at 75° C. for 3 hours and at 85° C. for 1 hour only. At this stage, the reaction mass was cooled to room temperature then aqueous portion (˜180 mL) was siphoned out by vacuum filtration. The second monomer feed containing 147.63 g of styrene and 17.37 g of commercially available technical grade DVB solution which contains 9.9 g of DVB was added to the cross-linked copolymer beads of the first component. Then, the monomer composition of the cross-linked copolymer of the second component was allowed to imbibe in the cross-linked copolymer beads of first component over a period of 2 hours. Then fresh aqueous phase consisting of 540 mL of water, 0.81 g of HPEC and 2.7 g of DSP was charged to the kettle. The polymerization reaction was continued under stirring (100 to 120 rpm) at 75° C. for 3 hours then at 85° ° C. for 3 hours and further at 95° C. for 3 hours. The content of the reaction kettle was then cooled to room temperature and beads of two component cross-linked copolymer were washed until water washings showed no foaming. The product was dried in an oven at 100° C. for 8 hours. The yield of the two component cross-linked copolymer beads based on total monomer charge was 68% which indicates second component monomer conversion to polymer was incomplete.

### Example 9

The experiment was carried out as described in Example 8, except that after the second monomer feed was imbibed in the cross-linked copolymer beads already formed, the polymerization was carried out at 75° C. for 3 hours and then at 85° ° C. for 3 hours. The content of the reaction kettle was then cooled to room temperature. The two component cross-linked copolymer beads was sticky in nature and had styrene smell. The beads were washed with deionized water and dried in an oven at 100° C. for 8 hours. The yield of the two component cross-linked copolymers beads based on total monomer charge was 70% indicating incomplete polymerization of the second monomer feed.

### Example 10

The experiment was carried out as described in Example 8, except that after addition of the monomer composition of first component followed by sticky stage, the polymerization was carried out at 75° ° C. for 1 hour and reaction was stopped, and aqueous portion (˜180 mL) was siphoned out by vacuum filtration. Then second monomer component containing 147.63 g of styrene and 17.37 g of commercially available technical grade DVB solution containing 9.90 g of DVB and 0.165 g of BPO was added and further continued reaction as mentioned in Example 8. The yield of the two component cross-linked copolymers beads based on total monomer charge was greater than 95%.

### Example 11

The experiment was carried out as described in Example 8, except that after addition of the monomer composition of first component followed by sticky stage, the polymerization was carried out at 75° C. for 3 hours and reaction was stopped, and aqueous portion (˜180 mL) was siphoned out by vacuum filtration. Then monomer composition of the second component containing 147.63 g of styrene and 17.37 g of commercially available technical grade DVB solution containing 9.90 g of DVB and 0.165 g of BPO was added and further the reaction continued as mentioned in Example 8. The yield of the two component cross-linked copolymers beads based on total monomer charge was greater than 95%.

### Example 12

The experiment was conducted as described in Example 1, except that the protective agent HPMC was replaced with HPEC in both first and second aqueous phase system. The monomer composition of the second component was containing 134.2 g of styrene and 15.8 g of commercially available technical grade DVB solution containing 9.006 g of DVB and 0.6 g of BPO, polymerization reaction was continued as mentioned in Example 1. The yield of the two component cross-linked copolymer beads was greater than 95%.

### Example 13

The experiment was conducted as described in Example 12, except that the second monomer feed composition containing 214.7 g of styrene and 25.3 g of commercially available technical grade DVB solution containing 14.42 g of DVB and 0.96 g of BPO was added. Then, monomer composition of the cross-linked copolymer of the second component was allowed to imbibe in the cross-linked copolymer beads of first component over a period of 2 hours. Then fresh aqueous phase consisting of 840 mL of water, 1.26 g of HPEC and 4.2 g of DSP was added to the reaction kettle. The polymerization reaction was continued under stirring (100 to 120 rpm) at 75° C. for 3 hours and then at 85° C. for 3 hours and further at 95° C. for 3 hours. The content of the reaction kettle was then cooled to room temperature and beads of two component cross-linked copolymer were filtered and washed until water washings showed no foaming. The product was dried in an oven at 100° C. for 8 hours. The yield of the two component cross-linked copolymer beads based on total monomer charge was greater than 95%.

### Example 14

To a one litre, four-neck reaction kettle equipped with a stirrer, a thermocouple probe, a water bath, a temperature controller and a condenser, 600 g of water was added, followed by 2.4 g of polyvinyl alcohol (PVA) (Grade: % Hydrolysis: 85 to 89 by weight and viscosity 20 to 30 cPs at 20° C.) 3 g of sodium lignosulfonate (SLS) (Grade: Viscosity of 50% w/v aqueous solution at 25° C. about 15 to 25 cPs) and 18 g of sodium chloride. The agitator speed was set at 200-300 rpm after which the contents were heated to 75° C. over a period of 20 to 30 minutes then agitator speed was adjusted to 60 to 70 rpm. After 15 minutes, the first monomer feed containing 289.47 g of styrene and 10.53 g of commercially available technical grade DVB solution containing 6.00 g of DVB and 1.2 g of BPO was added. The temperature was maintained at 75° C. A sticky copolymer mass was formed after 45 minutes. At this stage to avoid agglomeration of reaction mass the stirrer speed was increased to 100-120 rpm, and polymerization was continued for 3 hours. Then polymerization temperature was raised to 85° C. continued for 3 hours and then at 95° C. for 3 hours. The reaction mass was cooled to room temperature then aqueous portion was filtered and copolymer beads were washed and dried in an oven at 80 to 90° C. until the moisture content of beads was less than 2%. 50 g of dried polymer beads of first component were taken into reaction kettle, to this the second monomer feed containing 85.96 g of styrene and 14.04 g of commercially available technical grade DVB solution containing 8.00 g of DVB and 0.4 g of BPO was added. Then, monomer composition of second component was allowed to imbibe in the cross-linked copolymer beads of first component over a period of 2 hours. Then fresh aqueous phase consisting of 300 mL of water, 1.2 g of PVA, 1.5 g of SLS and 9 g of sodium chloride was added to the reaction kettle. The reaction mass was stirred at 100-120 rpm and polymerization reaction continued at 75° C. for 3 hours and then at 85° C. for 3 hours and further at 95° C. for 3 hours. The contents of the reaction kettle were then cooled to room temperature. The beads of two component cross-linked copolymer were washed with water until the wash water did not show foaming. The product was dried in an oven at 100° C. for 8 hours. The yield of the two component cross-linked copolymer beads based on total monomer charge was greater than 95%.

### Example 15

To a one litre, four-neck reaction kettle equipped with a stirrer, a thermocouple probe, a water bath, a temperature controller and a condenser, 600 g of water was added, followed by 2.4 g of PVA, 3 g of SLS and 18 g of sodium chloride was added. The agitator speed was set at 200-300 rpm after which the contents were heated to 75° C. over a period of 20 to 30 minutes then agitator speed was adjusted to 60 to 70 rpm. After 15 minutes, the first monomer feed containing 284.3 g of styrene and 15.80 g of commercially available technical grade DVB solution containing 9.006 g of DVB and 1.2 g of BPO was added. The temperature was maintained at 75° C. A sticky copolymer mass was formed after 45 minutes. At this stage the stirrer speed was increased to 100-120 rpm, to avoid agglomeration of reaction mass, and polymerization was continued for 3 hours. Then polymerization temperature was raised to 85° C. continued for 3 hours and then at 95° C. for 3 hours. The reaction mass was cooled to room temperature then aqueous portion was filtered and copolymer beads were washed and dried in an oven at 80 to 90° C. until the moisture content of beads was less than 2%. 60 g dried polymer beads of first component were taken into reaction kettle, to this the second monomer feed containing 99.36 g of styrene and 18.64 g of commercially available technical grade DVB solution containing 10.625 g of DVB and 0.472 g of BPO was added. Then, monomer composition of second component was allowed to imbibe in the cross-linked copolymer beads of first component over a period of 2 hours. Then fresh aqueous phase consisting of 400 ml of water, 1.6 g of PVA, 2 g of SLS and 12 g of sodium chloride was added to the reaction kettle. The reaction mass was stirred at 100-120 rpm and polymerization reaction continued at 75° C. for 3 hours and then at 85° C. for 3 hours and further at 95° C. for 3 hours. The contents of the reaction kettle were then cooled to room temperature. The beads of two component cross-linked copolymer were washed with water until the wash water did not show foaming. The product was dried in an oven at 100° C. for 8 hours. The yield of the two component cross-linked copolymer beads based on total monomer charge was greater than 95%.

### Example 16

To a one litre, four-neck reaction kettle equipped with a stirrer, a thermocouple probe, a water bath, a temperature controller and a condenser, 400 g of water was added, followed by 0.6 g of HPEC and 2.0 g of DSP. The agitator speed was set at 200-300 rpm after which the contents were heated to 75° C. over a period of 20 to 30 minutes. Then agitator speed was adjusted to 60 to 70 rpm. After 15 minutes, the first monomer feed containing 189.45 g of styrene and 10.55 g of commercially available technical grade DVB solution containing 6.013 g of DVB and 0.8 g of BPO was added. The temperature was maintained at 75° C. A sticky copolymer mass was formed after 45 minutes. At this stage the stirrer speed was increased to 100-120 rpm, to avoid agglomeration of reaction mass, and polymerization was continued for 3 hours. Then polymerization temperature was raised to 85° C. continued for 3 hours and then at 95° C. for 3 hours. The reaction mass was cooled to room temperature then aqueous portion was filtered and copolymer beads were washed and dried in an oven at 80 to 90° C. until the moisture content of beads less than 2%. 150 g of dried polymer beads of first component was taken into reaction kettle, to this the second monomer feed containing 232.45 g of styrene and 32.55 g of commercially available technical grade DVB solution containing 18.55 g of DVB and 1.06 g of BPO was added. Then, monomer composition of second component was allowed to imbibe in the cross-linked copolymer beads of first component over a period of 2 hours. Then fresh aqueous phase consisting of 1040 mL of water, 1.56 g of HPEC and 5.2 g of DSP was added to the reaction kettle. The reaction mass was stirred at 100-120 rpm and polymerization reaction continued at 75° C. for 3 hours and then at 85° C. for 3 hours and further at 95° C. for 3 hours. The contents of the reaction kettle were then cooled to room temperature. The beads of two component cross-linked copolymer were washed with water until the wash water did not show foaming. The product was dried in an oven at 100° ° C. for 8 hours. The yield of the two component cross-linked copolymer beads based on total monomer charge was greater than 95%.

### Example 17

To a one litre, four-neck reaction kettle equipped with a stirrer, a thermocouple probe, a water bath, a temperature controller and a condenser, 200 g of water was added, followed by 0.35 g of HPEC, 1.65 g of tri sodium phosphate (TSP) and 0.47 g of SLS. The agitator speed was set at 200-300 rpm after which the contents were heated to 75° C. over a period of 20 to 30 minutes then agitator speed was adjusted to 60 to 70 rpm. After 15 minutes, the first monomer feed containing 111.44 g of styrene and 6.21 g of commercially available technical grade DVB solution containing 3.54 g of DVB and 0.47 g of BPO was added. The temperature was maintained at 75° C. A sticky copolymer mass was formed after 45 minutes. At this stage the stirrer speed was increased to 100-120 rpm, to avoid agglomeration of reaction mass, and polymerization was continued for 3 hours. Then polymerization temperature was raised to 85° C. continued for 3 hours and then at 95° C. for 3 hours. The content of the reaction kettle was cooled to room temperature and then aqueous portion (˜180 mL) was siphoned out. The second monomer feed containing 174.0 g of styrene and 20.5 g of commercially available technical grade DVB solution containing 11.68 g of DVB and 0.78 g of BPO was added to the cross-linked copolymer beads of the first component. Then, monomer composition of the cross-linked copolymer of the second component was allowed to imbibe in the cross-linked copolymer beads of first component over a period of 2 hours. Then fresh aqueous phase consists of 510 ml of water, 0.9 g of HPEC, 4.2 g of TSP and 1.2 g of SLS was added to the reaction kettle. The reaction mass was stirred at 100-120 rpm and polymerization reaction continued at 75° ° C. for 3 hours and then at 85° C. for 3 hours and further at 95° C. for 3 hours. The content of the reaction kettle was then cooled to room temperature and beads of two component cross-linked copolymer were filtered and washed until water washings showed no foaming. The product was dried in an oven at 100° C. for 8 hours. The yield of the two component cross-linked copolymer beads based on total monomer charge was greater than 95%.

### Example 18

To a one litre, four-neck reaction kettle equipped with a stirrer, a thermocouple probe, a water bath, a temperature controller and a condenser, 200 g of water was added, followed by 0.35 g of HPEC and 1.18 g of DSP. The agitator speed was set at 200-300 rpm after which the contents were heated to 75° C. over a period of 20 to 30 minutes then agitator speed was adjusted in the range of 60 to 70 rpm. After 15 minutes, the first monomer feed containing 111.44 g of styrene and 6.21 g of commercially available technical grade DVB solution containing 3.54 g of DVB and 0.47 g of BPO was added. The temperature was maintained at 75° C. A sticky copolymer mass was formed after 45 minutes. At this stage the stirrer speed was increased in the range of 100 to 120 rpm, to avoid agglomeration of reaction mass, and polymerization was continued for 3 hours. Then polymerization temperature was raised to 85° C. continued for 3 hours and then at 95° C. for 3 hours. The content of the reaction kettle was cooled to room temperature and then aqueous portion (˜175 mL) was siphoned out. The second monomer feed containing 177.4 g of styrene and 17.1 g of commercially available technical grade DVB solution containing 9.75 g of DVB, 2.06 g of 1,7-octadiene and 0.78 g of BPO was added to the cross-linked copolymer beads of first component. Then, monomer composition of the cross-linked copolymer of the second component to was allowed to imbibe in the cross-linked copolymer beads of first component over a period of 2 hours. Then fresh aqueous phase consisting of 505 mL of water, 0.9 g of HPEC and 2.98 g of DSP was added to the reaction kettle. The reaction mass was stirred at 100-120 rpm and polymerization reaction continued at 75° C. for 3 hours and then at 85° C. for 3 hours and further at 95° C. for 3 hours. The content of the reaction kettle was then cooled to room temperature and beads of two component cross-linked copolymer were filtered and washed until water washings showed no foaming. The product was dried in an oven at 100° C. for 8 hours. The yield of the two component cross-linked copolymer beads based on total monomer charge was greater than 95%.

### Example 19

The experiment was carried out as described in Example 18, except that the second monomer feed was composed of 177.4 g of styrene and 17.1 g of commercially available technical grade DVB solution containing 9.75 g of DVB, 2.06 g of trivinyl cyclohexane (TVCH), 0.78 g of BPO and 0.1 g of dicumyl peroxide (DCP). After the polymerization reaction, the contents of the reaction kettle were cooled to room temperature and the beads of two component cross-linked copolymer were washed with water until water washings showed no foaming. The product was dried in an oven at 100° C. for 8 hours. The yield of the two component cross-linked copolymer beads based on total monomer charge was greater than 95%.

### Example 20

To a two litre, four-neck reaction kettle, equipped with a stirrer, a thermocouple probe, a water bath, a temperature controller and a condenser, 920 g of water was added, followed by 0.75 g of HPEC and 5 g of DSP. The agitator speed was set at 200-300 rpm after which the reaction mass was heated to 75° C. over a period of 20 to 30 minutes then agitator speed was adjusted to 60 to 70 rpm. After 15 minutes, the first monomer feed containing 484.2 g of styrene and 15.8 g of commercially available technical grade D V Bsolution containing 9 g of D V Band 2.0 g of BPO was added. The temperature was maintained at 75° C. A sticky copolymer mass was formed after about 80 minutes. At this stage the stirrer speed was increased to 100-120 rpm, to avoid agglomeration of reaction mass, and polymerization was continued for 3 hours. Then polymerization temperature was raised to 85° C. continued for 3 hours and then at 95° C. for 3 hours. The reaction mass was then cooled to room temperature. The beads were filtered and washed with water until the wash water did not show foaming. The beads were dried in oven between 80 and 85° C., till moisture content was less than 2%. The yield of copolymer beads based on total monomer charge was greater than 95%.

### Example 21

Monomer feed composition of the second component consisting of 20.6 g of styrene, 10.85 g of commercially available technical grade DVB solution containing 6.2 g of DVB, 174.55 g of methyl methacrylate (MMA) and 0.72 g of AIBN was added to 100 g copolymer beads of Example 20. During next 2 hours the cross-linked copolymer beads already formed, fully imbibed the monomer composition of the second component. At this point, the aqueous phase consisting of 800 mL of water, 2.4 g of hydroxy ethylcellulose (HEC) (Grade: Viscosity of 2% w/v aqueous solution at 25° C. is about 5000 to 5800 cPs) and 2.4 g of carboxy methylcellulose (CMC) (Grade: Viscosity of 1% w/v aqueous solution at 25° C. about 40 to 60 cPs), 1.2 g of SLS and 40 g of sodium chloride was charged in to the reaction kettle. The polymerization was continued at 75° C. for 3 hours and then at 85° C. for 3 hours and further at 95° C. for 3 hours. Then the reaction mass was cooled to room temperature. The beads of two component cross-linked copolymer were washed with water until the wash water did not show foaming. The beads were dried in an oven at 85° C. for 8 hours, resulting in greater than 95% yield based on total monomer charge.

### Example 22

Monomer feed composition of the second component consisting of 84 g of styrene, 12.6 g of commercially available technical grade DVB solution containing 7.2 g of DVB, 143.4 g of MMA and 0.84 g of AIBN was added to 100 g of cross-linked copolymer beads obtained in Example 20. During next two hours the cross-linked copolymers beads already formed, fully imbibed the monomer feed composition of the second component. At this point, the aqueous phase consisting of 800 mL of water, 2.4 g of HEC, 2.4 g of CMC, 1.2 g of SLS and 40 g of sodium chloride was charged in to the reaction kettle. The polymerization was continued at 75° C. for 3 hours and then at 85° C. for 3 hours and further at 95° ° C. for 3 hours. Then the reaction mass was cooled to room temperature. The beads of two component cross-linked copolymer were washed with water until the wash water did not show foaming. The beads were dried in an oven at 80-85° C. for 8 hours, resulting in yield of copolymer beads greater than 95% based on total monomer charge.

### Example 23

Monomer feed composition of the second component consisting of 99 g of styrene, 11.58 g of commercially available technical grade DVB solution containing 6.6 g of DVB, 109.4 g of MMA and 0.76 g of AIBN was added to 100 g copolymer beads obtained in Example 20. During next 2 hours these cross-linked copolymer beads already formed fully imbibed the monomer feed composition of the second component. At this point, the aqueous phase consisting of 800 mL of water, 2.4 g of HEC, 2.4 g of CMC, 1.2 g of SLS and 40 g of sodium chloride was added. The reaction mass was held at 75° C. for 3 hours and then at 85° C. for 3 hours and further at 95° C. for 3 hours. Then the reaction mass was cooled to room temperature. The beads of two component cross-linked copolymer were washed with water until the wash water did not show foaming. The beads were dried in an oven at 80-85° C. for 8 hours, resulting in greater than 95% yield based on total monomer charge.

### Example 24

Monomer feed composition of the second component consisting of 120 g of styrene, 12.6 g of commercially available technical grade DVB solution containing 7.2 g of DVB, 107.4 g of MMA and 0.84 g of AIBN was added to 100 g of cross-linked copolymer beads synthesized as described in Example 20. During next 2 hours the cross-linked beads already formed fully imbibed the monomer feed composition of the second component. At this point, the aqueous phase consisting of 800 mL of water, 2.4 g of HEC, 2.4 g of CMC, 1.2 g of SLS and 40 g of sodium chloride was added. The polymerization was carried out at 75° C. for 3 hours and then temperature was raised to 85° C. and maintained for 3 hours. Further temperature was raised to 95° C. and maintained for 3 hours. Then the reaction mass was cooled to room temperature. The beads of two component cross-linked copolymer were washed with water until the wash water did not show foaming. The beads were dried in an oven at 85° C. for 8 hours, resulting in greater than 95% yield based on total monomer charge.

### Example 25

### Soxhlet Extraction of Two Component Cross-Linked Copolymers in the Bead Form.

To a round bottom flask equipped with an oil bath, Soxhlet apparatus and reflux condenser, 200 mL of toluene was added to the round bottom flask and 10 g of polymer beads (W1) to the thimble of the Soxhlet apparatus. The flask was heated so that toluene refluxed at 112±2° C. During reflux, polymer beads were extracted continuously with toluene over a period of 8 hours. Then the flask was cooled to room temperature, polymer beads were collected and washed with methanol. Then polymer beads were transferred into a pre-weighed Petri-dish, pre-dried at room temperature then dried in an oven at 110±2° C. till it attained a constant weight, this weight was recorded as dry weight of polymer beads (W2). Percent weight loss of extracted polymer beads was calculated by following formula. The results are tabulated in Table 1.

$$Weight loss ( \% ) = [ ( {W}_{1} - {W}_{2} ) \times 100 ] / {W}_{1}$$

TABLE 1
Polymer beads weight loss after solvent extraction

| Example No | Weight loss (%) |
|---|---|
| Example 1 | 2.252 |
| Example 2 | 5.902 |
| Example 3 | 3.764 |
| Example 4 | 2.215 |
| Example 5 | 2.2015 |
| Example 6 | 2.322 |
| Example 7 | 2.174 |

### Example 26

### Swelling Behaviour of Two Component Cross-Linked Copolymers in Toluene

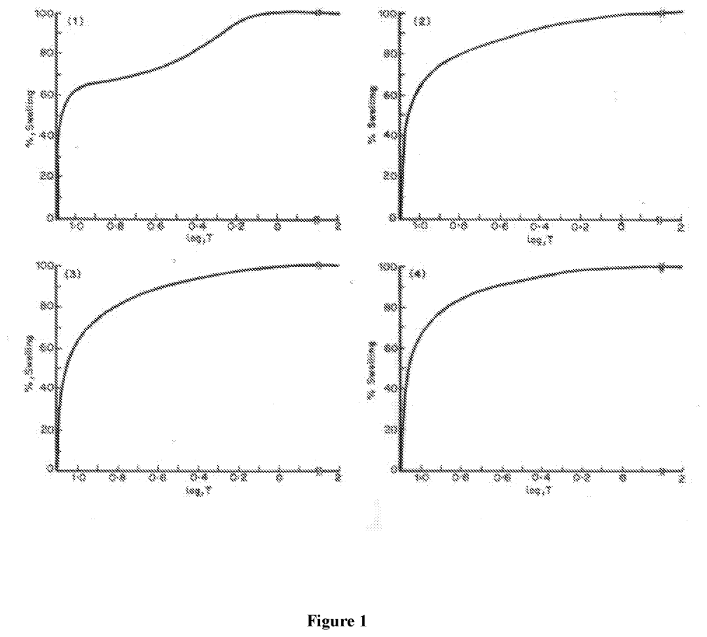

In to a 100 mL measuring cylinder with lid 80 mL of toluene was taken and 10 g of dry polymer beads were gently added to toluene and covered with lid. Then the measuring cylinder was gently tapped and kept on the horizontal surface, recorded volume of polymer beads (V_{T}) for every 5 minutes intervals till 1 hour; every 15 minutes intervals till 6 hrs; then at every 6 hours intervals till 100^{th} hour of swelling time. The maximum swelling volume is recorded as V_{M}, then measured swelling in percent (Swelling, %) by following formula. FIG. 1 shows plotted curves of swelling pattern of copolymer beads synthesized by current invention.

$$Swelling ( \% ) = [ {V}_{T} \times 100 ] / {V}_{M}$$

### Synthesis of Strong Acid Cation Exchange Resins

### Example 27

To a one litre, four-neck sulphonation glass kettle equipped with anchor stirrer, a thermometer pocket, heating mantle, a temperature controller and a water circulated condenser, was added 100 g of dried styrene-DVB two component copolymer beads obtained in Example 1. Then 400 mL of sulfuric acid (Purity: 93 to 95%) was charged to the kettle. The stirrer speed was adjusted to about 200 rpm. The reaction mass was heated slowly to 110° C.±2° C. and maintained for 6 hours. The reaction mass was then cooled to room temperature. Then the sulfonated resin was separated from excess of sulfuric acid by drawing out sulfuric acid from the reaction mass. The sulfonated resin mass was subjected to programmed hydration process in which the resin mass was treated with sulfuric acid solutions of concentrations of 85%, 78%, 65%, 45%, 30%, 25% and 15% w/w. 250 mL aliquot of the 85% sulfuric acid solution was added to sulphonated mass and stirred at room temperature for 30 to 45 minutes. There after the aliquot was siphoned off and the procedure was repeated with next aliquot of 78% sulfuric acid concentration. The procedure was continued till the last wash was with 15% w/w Sulphuric acid solution. Finally, the sulfonated resin was washed with deionized water till wash water pH was neutral. The strong acid cation exchange resin yield was about 400 mL. The resin had 51% moisture, total exchange capacity (TEC) 1.8 eq/L and dry weight capacity 4.4 milli equivalents per gram (meq/g). The whole beads count was more than 95%.

### Procedure for Whole Bead Count Measurement

The wet resin sample was spread into a Petri-dish and observed under optical microscope. The number of total beads visible was counted and also the number of cracked/broken beads was counted. Then the Petri-dish position was changed and another portion of the resin was viewed and the procedure repeated. About 25 to 30 observations were made with different aliquots taken from same resin sample, an average crack or broken beads in percent number was calculated by following formula.

$$Cracked / broken beads ( \% ) = \frac{( Number of cracked + broken beads ) \times 100}{\begin{matrix}Number of total beads ( cracked + \\ broken + intact beads )\end{matrix}}$$

$$Whole bead count ( \% ) = 100 - ( \% cracked / broken beads ) Dry resin swelling study in water$$

The resin was dried at 100° C. in oven to obtain moisture free resin. About 10 g accurately weighed dry resin was slowly added to a graduated measuring cylinder of 50 mL capacity, containing deionised water. The cylinder was tapped gently to settle the resin. After 5 minutes volume of the resin was noted. Thereafter, the volume of the resin was noted at every five minutes up to 2 hours and then after 24 hours. Since there was no change in volume of the resin after 20 minutes, readings between 20 minutes and 24 hrs are not included in Table 2.

$$\% Swelling ratio ( v / w ) = ( Swollen volume of resin in water \times 100 ) / dry weight of resin ( w )$$

TABLE 2
Dry resin swelling

| | | Dry resin | Swelling Time in minutes | | | | |
|---|---|---|---|---|---|---|---|
| | Weight of | swelling, | 5 | 10 | 15 | 20 | 1440 |
| Resin | dry resin, g | mL | Resin volume in mL | | | | |
| Indion 225H | 10.0144 | 13 | 22 | 24 | 26 | 26 | 26 |
| Example 27 | 10.0063 | 12 | 20 | 22 | 24 | 24 | 24 |

### Example 28

The sulfonation reaction was conducted as described in Example 27, with cross-linked copolymer beads obtained in Example 1. The sulfonation time was restricted to 1 hour. During hydration step, the bead surface was destroyed, leading to uneven and highly cracked resin beads as seen under optical microscope.

### Example 29

The sulfonation reaction was conducted as described in Example 27, with cross-linked copolymer beads synthesized as described in Example 1. The sulfonation time was restricted to 2 hours. The product had reddish brown colour and sulfonated resin yield was about 300 mL. The resin had about 41.3% moisture, and showed TEC of 1.56 eq/L and dry weight capacity 3.21 meq/g, and whole beads count 90%.

### Example 30

The sulfonation reaction was conducted as described in Example 27, with copolymer beads obtained in Example 1. The sulfonation time was restricted to 3 hours. The resin had reddish brown colour and sulfonated resin yield was about 340 mL. The resin had about 42.7% moisture, and showed TEC 1.68 eq/L, dry weight capacity 3.36 meq/g, and whole beads count 95%.

### Example 31

The sulfonation reaction was conducted as described in Example 27, with cross-linked copolymer beads obtained in Example 1. The sulfonation time was restricted to 4 hours. The resin had reddish brown colour and the sulfonated resin yield was about 360 mL. The resin had about 44.8% moisture, TEC 1.72 eq/L and dry weight capacity 3.84 meq/g. The whole beads count was 95%.

### Example 32

The sulfonation reaction was conducted as described in Example 27, using cross-linked copolymer beads obtained in Example 2. The resin had 61.2% moisture, TEC 1.26 eq/L and dry weight capacity 3.36 meq/g. The whole beads count was 94%.

### Example 33

The sulfonation reaction was conducted as mentioned in Example 27, using cross-linked copolymer beads obtained in Example 8. The resin had 57.2% moisture, TEC 1.33 eq/L and dry weight capacity 3.46 meq/g. The whole beads count was 94%.

### Example 34

The sulfonation reaction was conducted as mentioned in Example 27, using cross-linked copolymer beads obtained in Example 9. The resin had about 58.5% moisture, TEC 1.32 eq/L and dry weight capacity 3.42 meq/g. The whole beads count was 94%.

### Example 35

The sulfonation reaction was conducted as mentioned in Example 27, using cross-linked copolymer beads obtained in Example 10. The resin had about 49.5% moisture, TEC 1.80 eq/L and dry weight capacity of 4.42 meq/g. The whole beads count was 95%.

### Example 36

The sulfonation reaction was conducted as mentioned in Example 27, using cross-linked copolymer beads obtained in Example 11. The resin had about 50.8% moisture, TEC 1.82 eq/L and dry weight capacity of 4.56 meq/g. The whole beads count was 95%.

### Example 37

The sulfonation reaction was conducted as mentioned in Example 27, using cross-linked copolymer beads obtained from Example 1, except that the amount of sulfuric acid used was 100 mL. The resin yield was 290 mL. The resin had about 41% moisture, TEC 1.56 eq/L and dry weight capacity 3.49 meq/g. The whole beads count was 70%.

### Example 38

The sulfonation reaction was conducted as mentioned in Example 27, using cross-linked copolymer beads obtained in Example 1 except that the sulfuric acid quantity used was 200 mL. The resin yield was 360 mL. The resin had about 49.81% moisture, TEC was 1.70 eq/L and dry weight capacity was 4.21 meq/g. The whole beads count was 80%.

### Example 39

The sulfonation reaction was conducted as mentioned in Example 27, using cross-linked copolymer obtained in Example 1 except that the amount of sulfuric acid used was 300 ml. The resin yield was 410 mL, had about 49.71% moisture, TEC 1.72 eq/L and dry weight capacity 4.49 meq/g. The whole beads count was 95%.

### Example 40

The sulfonation reaction was conducted as mentioned in Example 27, with cross-linked copolymer beads obtained from Example 1 except that the amount of sulfuric acid used was 400 mL and purity of sulfuric acid was 98% w/w. The resin yield was 450 mL, had about 50.87% moisture, TEC of 1.85 eq/L and dry weight capacity of 4.55 meq/g. The whole beads count was 95%.

### Example 41

The sulfonation reaction was conducted as mentioned in Example 27, with cross-linked copolymer beads obtained from Example 1 except that the amount of sulfuric acid used was 600 mL and purity of sulfuric acid was 94% w/w. The sulfonation reaction was stopped after 2 hours. The resin yield was 320 mL, had about 41.72% moisture, TEC of 1.56 eq/L and dry weight capacity of 3.49 meq/g.

### Example 42

The sulfonation reaction was conducted as described in Example 27, with copolymer beads obtained from Example 12. The resin had reddish brown colour and sulfonated resin yield was about 430 mL. The resin had about 49.9% moisture, and showed TEC 1.64 eq/L, dry weight capacity 4.3 meq/g, and whole beads count was 85%.

### Example 43

The sulfonation reaction was conducted as described in Example 27, with copolymer beads obtained from Example 13. The resin had reddish brown colour and sulfonated resin yield was about 460 mL. The resin had about 52.65% moisture, and showed TEC 1.60 eq/L, dry weight capacity 4.36 meq/g, and whole beads count was 80%.

### Example 44

The sulfonation reaction was conducted as described in Example 27, with copolymer beads obtained from Example 14. The resin had reddish brown colour and sulfonated resin yield was about 450 mL. The resin had about 56.56% moisture, TEC 1.72 eq/L, dry weight capacity 4.41 meq/g, and whole beads count was 80%.

### Example 45

The sulfonation reaction was conducted as described in Example 27, with copolymer beads obtained from Example 15. The resin had reddish brown colour and sulfonated resin yield was about 450 mL. The resin had about 51.53% moisture, TEC 1.72 eq/L, dry weight capacity 4.30 meq/g, and whole beads count was 70%.

### Example 46

The sulfonation reaction was conducted as described in Example 27, with copolymer beads obtained from Example 16. The resin had reddish brown colour and sulfonated resin yield was about 390 mL. The resin had about 48.18% moisture, TEC 1.8 eq/L, dry weight capacity 4.54 meq/g, and whole beads count was 90%.

### Example 47

The sulfonation reaction was conducted as described in Example 27, with copolymer beads obtained from Example 18. The resin had black colour and sulfonated resin yield was about 450 mL. The resin had about 53.86% moisture, TEC 1.5 eq/L, dry weight capacity 4.27 meq/g, and whole beads count was 85%.

### Example 48

The sulfonation reaction was conducted as described in Example 27, with copolymer beads obtained from Example 19. The resin had black colour and sulfonated resin yield was about 460 mL. The resin had about 53.81% moisture, TEC 1.34 eq/L, dry weight capacity 4.17 meq/g, and whole beads count was 75%.

### Example 49

Chloromethylation reaction was carried out in a glass kettle provided with an anchor type glass stirrer, a thermometer pocket and a water condenser. The reaction kettle was placed in a water bath, 168 g 50% formaldehyde solution in methanol (w/w). 15 g methanol, 40 g methylal, 46 g water and 10 g ferric chloride catalyst (40% solution in water) were placed into reaction kettle. 180 mL chlorosulfonic acid (CSA) was slowly added through the dropping funnel over a period of 5-6 hours at 38-40° C. Then, 100 g dry copolymer beads obtained in Example 21 were charged in to the reaction kettle under stirring at 20° C. Chloromethylation reaction was conducted at 38-40° C. for 6 hours and then reaction mass was cooled to 20-25° C. The reaction mass was quenched with three lots of 300 mL methanol, to decompose unreacted CMME. Finally the chloromethylated resin was washed with dilute alkali solution then with water till the pH of the wash water was neutral.

Amination was conducted in a reaction kettle provided with an anchor type glass stirrer, thermometer pocket and condenser. Chloromethylated resin beads of 100 mL transferred into the reaction kettle along with water. Excess water was removed from the chloromethylated beads. Then 200 mL of methylal was added into the reactor followed by about 2 mL of caustic lye to maintain pH in the range of 10-12. The mixture was stirred and cooled to 25° C. and 100 mL of trimethyl amine (30% aqueous solution of TMA) was added using an addition funnel over a period of 30 to 45 minutes. After mixing the contents at 25-30° C. for 30 minutes, reaction mass was heated to 42-45° C. and the reaction was continued for 6 hours. Then the mixture was heated to 80° C. and methylal was distilled off from the reaction mass. The reaction mass was cooled to room temperature and 50 mL of 7% (w/v) hydrochloric acid solution was added to the reaction mass. The reaction mass was stirred for another half an hour and then filtered, washed with deionized water. Obtained product yield of 290 mL of aminated resin by this process. The resin was tested for its properties as listed in Example 52.

### Example 50

The chloromethylation and amination reactions were conducted as mentioned in Example 49 except the polymer beads of Example 22 were used for the synthesis of anion resin. The resin properties were tested as listed in Example 52.

### Example 51

The chloromethylation and amination reactions were conducted as mentioned in Example 49 except the polymer beads of Example 23 were used for the synthesis of anion resin. The resin properties were tested as listed in Example 52.

### Example 52

Chloromethylation reaction was carried out in a glass reaction kettle provided with an anchor type glass stirrer, thermometer pocket and water condenser. The reaction kettle was placed in a water bath. To this was added 75 g of ethylene dichloride, 70 g of methanol-formaldehyde solution (50%, w/w), 6.5 g of methanol, 12.6 g of methylal, 11 g of water and 7.5 g of ferric chloride catalyst (40% solution). Then 50 mL of chlorosulfonic acid (CSA) was slowly added through dropping funnel over a period of 5-6 hours at 38-40° C. Then, 100 g of dry copolymer beads synthesized as described in Example 24 was charged into the reactor kettle under stirring at about 20° C. The reaction was conducted at 57±2° C. for 6 hours and then reaction mass was cooled to 18-25° C. To decompose the unreacted CMME, the reaction mass was quenched with methanol in three lots of 150 mL each. Finally the chloromethylated resin was washed with 300 ml of 1% alkali solution (w/v) followed by water wash till the pH of wash water to be neutral.

The chloromethylated resin prepared above was aminated with trimethyl amine (TMA). Aminaiton reaction was conducted as mentioned in Example 49. The resin was further tested for its properties and results are tabulated in Table 3.

TABLE 3
Characteristics of strong base anion exchange resins*

| Example | | | | |
|---|---|---|---|---|
| No | Moisture, % | TEC, eq/L | DWC, meq/g | Whole beads, % |
| 49 | 47.53 | 0.74 | 1.78 | greater than 90 |
| 50 | 50.0 | 0.75 | 2.08 | greater than 90 |
| 51 | 54.78 | 0.87 | 2.68 | greater than 85 |
| 52 | 52.4 | 1.02 | 3.01 | greater than 85 |

*As per ISI test method 7330-1988

### Resin Swelling Ratio in Water

The resins (Example 51 and 52) were dried at 70° C. in an oven to obtain moisture free resin. About 10 g accurately weighed dry resin was slowly added to a graduated measuring cylinder of 50 mL capacity, containing deionised water. The cylinder was tapped gently to settle the resin. After 5 minutes, the volume of the resin was noted and thereafter at every five minutes up to 2 hours and finally after 24 hrs. Since there were no volume changes after twenty minutes, the values in between are not listed in Table 4.

$$\% Swelling ratio ( v / w ) = ( Swollen volume of resin in water \times 100 ) / dry weight of resin ( w )$$

TABLE 4
Dry swelling data of SBA resins

| | | | Swelling time in minutes | | | | |
|---|---|---|---|---|---|---|---|
| | Resin | Dry resin | 5 | 10 | 15 | 20 | 1440 |
| Resin | weight g | volume ml | Resin volume in mL | | | | |
| Indion GS 300 | 10.0032 | 16 mL | 28 | 28 | 28 | 28 | 28 |
| Example 51 | 10.0092 | 15 mL | 27 | 27 | 27 | 27 | 27 |
| Example 52 | 10.0381 | 15 ml | 29 | 29 | 29 | 29 | 29 |

### Synthesis of Weak Acid Cation Exchange Resin

### Example 53

To a one litre, four-neck reaction kettle equipped with a stirrer, thermocouple probe, water bath, temperature controller and condenser, were added 400 g of water followed by 1.2 g of hydroxy ethylcellulose (HEC) (Grade—viscosity of 2% aq. solution at 25° C. is about 5000-5800 Cps). After dissolution of HEC, 1.2 g of carboxy methylcellulose (CMC) (Grade—viscosity of 1% aqueous solution at 25° C. is about 40-60 cPs) was added and mixed together. Then 0.6 g of sodium lignosulfonate (Grade—viscosity of 50% aqueous solution at 25° C. is about 15-25 cPs) followed by 130 g of sodium chloride was added. Temperature of this mixture was raised to 60 to 65° C. The stirrer speed was set between 200-300 rpm. The stirring speed was then adjusted to 60-70 rpm. After 15 minutes, the first monomer feed containing 20 g of methacrylic acid, 173 g of methyl acrylate and 7.1 g commercially available technical grade DVB solution containing 4.05 g DVB and 0.6 g benzoyl peroxide (BPO) and 0.6 g azobis-isobutyronitrile (AIBN) was added. The reaction kettle was heated to 65° ° C. After 45 to 50 minutes, sticky copolymer mass was formed. At this stage the stirrer speed was increased to 100-120 rpm, to avoid agglomeration, and polymerization was continued for 3 hours at 65° C. The temperature was then maintained at 75° C. and polymerization was continued for 3 hours, and then at 85° C. for 3 hours and then at 95° C. for another 3 hours. The contents of the reaction kettle were then cooled to room temperature and the beads of copolymer were washed with deionized water till the wash water was free from foam, and dried in an oven at 100° ° C. for 6-8 hours. The yield of the cross-linked copolymer beads based on monomer charge was 95%.

The second monomer solution was prepared by mixing 46.2 g of methyl methacrylate, 4.62 g of methacrylic acid, 76.54 g of methyl acrylate and 4.64 g of commercially available technical grade DVB solution containing 2.64 g of DVB and 0.57 g of AIBN. This monomer mixture was added to 50 g of cross-linked copolymer beads already formed in the first step. Over the next two hours the second monomer solution was imbibed in the cross-linked copolymer beads already formed. At this point, the aqueous phase consisting of 600 mL of water, 1.8 g of hydroxy ethyl cellulose (HEC) (Grade—viscosity of 2% aqueous solution at 25° C. is about 5000-5800 Cps), 1.8 g carboxy methylcellulose (CMC) (Grade—viscosity of 1% aq. solution at 25° C. is about 40-60 cPs), 1.0 g of sodium lignosulfonate (SLS) (Grade—viscosity of 50% aqueous solution at 25° C. is about 15-25 cPs) and 210 g of sodium chloride was charged in the reaction kettle. The reaction mass was stirred at 100-120 rpm and polymerization reaction was continued at 65° C. for 3 hours and then at 75° C. for 3 hours and further at 85° C. for 2 hours. 200 g of 46% caustic lye was added to the reaction kettle and the heating was continued at 85° C. for 3 hours and then at 95° C. for 3 hours. The reaction mass was then cooled to room temperature, filtered and washed with demineralized water. The yield of the weak acid cation exchange resin obtained was approximately 700 mL. The moisture content of the product was 45%, total exchange capacity was 2.76 eq/L and dry weight capacity was 6.46 meq/g. The product showed 120% swelling when converted from H to Na form.

### Example 54

This experiment was carried out as in Example 53, except that second monomer solution comprising 60.2 g of methyl methacrylate, 6.25 g of methacrylic acid, 37.65 g of methyl acrylate, 6.25 g of hydroxy ethyl methacrylate (HEMA), and 7.65 g of commercially available technical grade DVB solution containing 4.36 g of DVB and 0.51 g of AIBN was added to the 50 g cross-linked copolymer beads already formed in the first step. Over the next two hours the second monomer solution was imbibed in the cross-linked copolymer beads already formed in the first step. At this point, the aqueous phase consisting of 600 mL of water, 1.8 g of HEC, 1.8 g of CMC, 1.0 g of sodium lignosulfonate, and 120 g of sodium chloride was charged into the reaction kettle. The reaction mass was stirred at 100-120 rpm and polymerization reaction was continued at 65° C. for 3 hours and then at 75° C. for 3 hours and further at 85° C. for 2 hours. After that 200 g 46% (w/v) caustic lye was added and the heating continued at 85° C. for 3 hours and then at 95° C. for 3 hours. The reaction mass was cooled to room temperature, filtered and washed with demineralized water. The yield of the weak acid cation exchange resin obtained was approximately 490 mL. The product had 38% moisture, TEC 1.95 eq/L and dry weight capacity 5.41 meq/g. The product had swelling of 86% when converted from H to Na form.

### Example 55

Performance evaluation of strong acid cation (SAC) resin. The SAC resin product obtained as described in Example 27 was evaluated for performance in water demineralization and water softening applications. The procedure followed was as per ASTM Designation: D 2187-94 (Reapproved 2004). The performance of the resin made was compared with performance of commercial resin in H form for water demineralization and Na form for water softening applications.

### Procedure

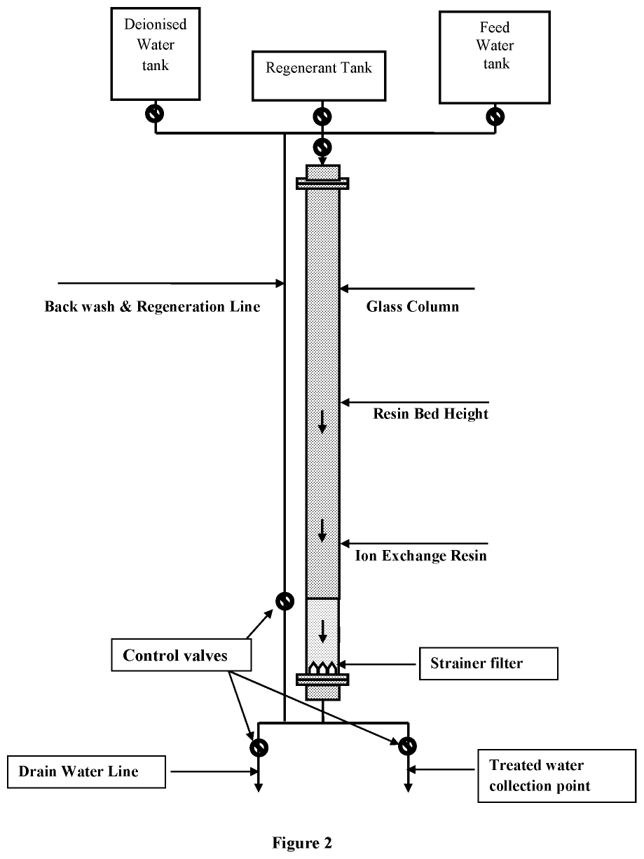

The procedure consisted of first preparing a resin column as depicted in the FIG. 2. A synthetic feed solution of 1000 L was prepared by dissolving accurately weighed quantities of 132.3 g of calcium chloride dihydrate, 182.7 g of magnesium chloride hexahydrate and 140.4 g of sodium chloride. These salts were dissolved and diluted to about 10 L in a polyethylene container. All of these salt solutions were further gently added to synthetic feed water tank and diluted to 1000 L with deionized water. The synthetic feed water quality parameters are tabulated in Table 5.

TABLE 5
The synthetic feed water quality parameters
for demineralization application

| Parameter | Concentration |
|---|---|
| Total Hardness | 180 ppm as CaCO₃ |
| Calcium hardness | 90 ppm as CaCO₃ |
| Magnesium hardness | 90 ppm as CaCO₃ |
| Sodium | 120 ppm as CaCO₃ |
| Total Cations | 300 ppm as CaCO₃ |
| Na/Total Cation % | 40 |

Four glass columns were filled with 300 mL each of resin prepared in Example 27 and another four columns with 300 mL of commercial resin (Indion 225H) comprising single component cross-linked copolymer in H form.

The feed solution prepared above was passed through the columns at a flow rate of 20 bed volume (BV)/hour in gravity flow mode. The water leaving the column outlet was checked for every 30 minutes for sodium content. The analysis was conducted by flame photometer method using sodium ion filter.

The experiment was stopped, when the concentration of sodium in the column outlet reached to 0.5 ppm. Total feed solution passed through the column was noted and operating exchange capacity (OEC) of the resin was calculated using following formula.

$$O E C ( g / C a C {O}_{3} / L ) = \frac{( Total cations , ppm as C a C {O}_{3} ) \times ( Output water quantity in L )}{Resin volume in L \times 1000} .$$

The first cycle is known as conditioning run. After conditioning run, the resin was regenerated by passing 5% w/v hydrochloric acid (HCl) solution through resin bed in counter current mode with 30 minutes contact time. The resin was rinsed with deionized water to remove residual acid from resin bed. The volume of water required to rinse the resin of Example 27 was 25 to 30% lower than that required for the commercial resin.

Subsequently three demineralization cycles were similarly conducted. The performance of the resin was evaluated at different regeneration levels of 40 g/L, 50 g/L, 60 g/L and 70 g/L of resin using 5% w/v HCl solution. These results are tabulated in Table 6 and Table 7.

TABLE 6
Operating exchange capacity in demineralization applications

| | Resin from Example | Commercial resin | |
|---|---|---|---|
| Regeneration | 27 OEC g as | Indion 225H OEC g | % OEC |
| Level, g/L | CaCO₃/L resin | as CaCO₃/L resin | enhancement |
| 40 | 39.38 | 35.71 | 10.28 |
| 50 | 49.85 | 43.83 | 13.73 |
| 60 | 54.42 | 46.07 | 18.12 |
| 70 | 62.72 | 53.08 | 18.16 |

TABLE 7
SAC resin performance in demineralization applications

| | Resin from Example 27 | Commercial resin Indion |
|---|---|---|
| | % OEC/TEC ratio based | 225H % OEC/TEC ratio based |
| Regeneration | on TEC as 90.0 g as | on TEC as 95.0 g as |
| Level g/L | CaCO₃/L resin | CaCO₃/L resin |
| 40 | 43.75 | 37.59 |
| 50 | 55.39 | 46.14 |
| 60 | 60.47 | 48.49 |
| 70 | 69.69 | 55.87 |

### Example 56: Operating Exchange Capacity: Water Softening Applications

A synthetic feed solution of 1000 L was prepared by dissolving accurately weighed quantities of 220.5 g of calcium chloride dihydrate, 304.5 g of magnesium chloride hexahydrate and 234.0 g of sodium chloride, these salts were dissolved and diluted to about 10 L in to separate poly containers. All of these salt solutions were further gently added to synthetic feed water tank and diluted to 1000 L with deionized water. The synthetic feed water quality parameters are tabulated in Table 8.

TABLE 8
The synthetic feed water quality parameters
used for water softening application

| Parameter | Concentration |
|---|---|
| Total Hardness | 300 ppm as CaCO₃ |
| Calcium hardness | 150 ppm as CaCO₃ |
| Magnesium hardness | 150 ppm as CaCO₃ |
| Sodium | 200 ppm as CaCO₃ |
| Total Cations | 500 ppm as CaCO₃ |
| Na/Total Cation % | 40 |

Example 27 resin about 500 mL was first converted to sodium (Na+) form by the following procedure.

The conversion of hydrogen (H+) form resin to Na+ form was carried out in a glass reactor provided with an anchor type glass stirrer, a thermometer pocket. 500 ml of H+ form resin was charged in the glass reactor, keeping minimum water (about 400 to 500 mL) for stirring. A 4% w/v sodium hydroxide solution about 2.5 BV against the resin taken for conversion to be added slowly in 60 to 90 minutes under stirring. The temperature was maintained below 40° ° C. throughout the neutralization reaction. After complete addition of the sodium hydroxide solution the pH of mother liquor was confirmed to be alkaline. The stirring was continued for next 30 minutes while pH was monitored. Then the resin was washed with water till wash water pH was between 6.5 and 8.0.

A glass column was filled with 300 mL of Na+ form converted resin of Example 27.

A second column was filled with 300 mL of commercial resin which was a single component cross-linked copolymer in Na+ form.

The feed solution prepared above was passed through the columns at a flow rate of 20 BV/hour in gravity flow mode. Water exiting at the column outlet was intermittently checked for total hardness content for every 30 minutes. The total hardness of water was measured by standard EDTA test method according to AWWA analytical test method.

The experiment was stopped, when the concentration of total hardness in column out let exceeded 1.0 ppm. Total feed solution passed through the column was noted and OEC of the resin was calculated.

The first cycle is known as conditioning cycle. Subsequently the resin was regenerated by passing 10% sodium chloride solution (w/v) through resin bed in co-current mode with 30 minutes contact time. Thereafter the resin was rinsed with deionized water to remove residual sodium chloride from resin bed. The volume of water required to rinse the resin was 20 to 25% lower when compared to that for conventional commercial resin. Subsequently seven softening cycles were similarly conducted. The results are tabulated in Table 9.

TABLE 9
SAC resin utility in water softening application

| | Example 27 in Na+ form | | | Commercial resin Indion 225Na form | | |
|---|---|---|---|---|---|---|
| | | | % OEC/TEC | | | % OEC/TEC |
| | OEC, | TH | (95.0 g as | OEC, | TH | (100.0 g as |
| Resin | g/Las | leakage, | CaCO₃/L in | g/Las | leakage, | CaCO₃/L in |
| Cycle | CaCO₃ | ppm | Na+ form) | CaCO₃ | ppm | Na+ form) |
| 1 | 58.25 | <1.0 | 61.31 | 56.84 | <1.0 | 56.84 |
| 2 | 57.54 | <1.0 | 60.56 | 56.84 | <1.0 | 56.84 |
| 3 | 58.25 | <1.0 | 61.31 | 57.54 | <1.0 | 57.54 |
| 4 | 58.25 | <1.0 | 61.31 | 56.84 | <1.0 | 56.84 |
| 5 | 57.54 | <1.0 | 60.56 | 56.14 | <1.0 | 56.14 |
| 6 | 57.54 | <1.0 | 60.56 | 56.84 | <1.0 | 56.84 |
| 7 | 58.25 | <1.0 | 61.31 | 56.84 | <1.0 | 56.84 |
| 8 | 58.95 | <1.0 | 62.05 | 57.54 | <1.0 | 57.54 |
| Average | 58.07 | <1.0 | 61.12 | 56.92 | <1.0 | 56.92 |

| Efficiency | 107.37% (OEC/TEC) | Base capacity ratio of OEC/TEC: |
|---|---|---|
| | | 56.92 considered as 100% |
| Rinse | 1.5 BV | 2.0 BV |

The strong acid cation exchange resin was evaluated for performance study for water de-mineralization application.

A synthetic feed solution for water demineralization application was prepared as follows.

A synthetic feed solution of 1000 L was prepared by dissolving accurately weighed quantities of 132.3 g of calcium chloride dihydrate, 182.7 g of magnesium chloride hexahydrate, 23.4 g of sodium chloride and 168.0 g of sodium bicarbonate. Each salt was dissolved and diluted to about 10 L in a polyethylene container. All these salt solutions were further gently added to synthetic feed water tank and diluted to 1000 L with deionized water. The synthetic feed water quality parameters are tabulated in Table 10.

TABLE 10
The synthetic feed water quality parameters
for demineralization application

| Parameter | Concentration |
|---|---|
| Total Hardness | 180 ppm as CaCO₃ |
| Calcium hardness | 90 ppm as CaCO₃ |
| Magnesium hardness | 90 ppm as CaCO₃ |
| Sodium | 120 ppm as CaCO₃ |
| Alkalinity | 100 ppm as CaCO₃ |
| Total Cations | 300 ppm as CaCO₃ |
| Na/Total Cation, % | 40.0 |
| Alkalinity/Total Cation, % | 33.3 |

A total of six demineralization cycles study was conducted using 5% HCl solution as a regenerant after each cycle. Each cycle was conducted till the resin treated water sodium content was less than 1 ppm as Sodium (Na). Average operating exchange capacity was noted for each resin after completing 6 cycles and OBC/TEC ratio was calculated. These results are tabulated in Table 11 and Table 12.

TABLE 11
Comparative study with Regeneration
level of 50 g (100% HCl)/L of resin

| | TEC as | OEC as | % OEC/ | % Whole bead |
|---|---|---|---|---|
| Example No | CaCO₃, g/L | CaCO₃, g/L | TEC | count |
| 27 | 90 | 49.85 | 55.39 | 98 |
| 29 | 78 | 41.22 | 52.84 | 95 |
| 30 | 84 | 44.46 | 52.93 | 95 |
| 31 | 86 | 46.24 | 53.77 | 95 |
| 35 | 90 | 49.58 | 55.09 | 95 |
| 36 | 91 | 45.16 | 49.63 | 95 |
| 37 | 78 | 46.25 | 59.29 | 70 |
| 38 | 85 | 47.17 | 55.49 | 80 |
| 39 | 86 | 47.41 | 55.13 | 95 |
| 40 | 92.5 | 48.56 | 52.50 | 95 |
| 41 | 78 | 47.41 | 60.78 | 95 |
| 42 | 82 | 45.13 | 55.04 | 85 |
| 43 | 80 | 42.73 | 53.40 | 85 |
| 44 | 86 | 47.73 | 55.50 | 80 |
| 45 | 86 | 46.33 | 53.87 | 70 |
| 46 | 90 | 48.20 | 53.56 | 90 |
| Indion 225 H | 94 | 50.30 | 53.51 | >90 |

TABLE 12
Comparative study with Regeneration level
of 40 g (100% HCl)/L of resin exchange

| | Total exchange | Operating exchange | |
|---|---|---|---|
| Resin from | capacity (TEC) as | capacity (OEC) as | |
| Example No. | CaCO₃, g/L | CaCO₃, g/L | % OEC/TEC |
| 37 | 78 | 41.69 | 53.43 |
| 41 | 78 | 39.78 | 51.00 |
| 44 | 86 | 42.12 | 48.97 |
| 45 | 86 | 40.21 | 46.75 |
| Indion 225 H | 94 | 42.12 | 44.80 |

### Example 57

### Performance Evaluation of Strong Base Anion Exchange Resin

The strong base anion exchange resin product obtained in the Example 52 was evaluated for performance in demineralized water applications. The procedure followed was as per ASTM Designation: D 2187-94. The performance of the resin made in this invention, was compared with performance of commercial resin Indion GS300 in chloride (Cl) form resin for water demineralization applications. The experimental set up is depicted in the FIG. 2.

A synthetic feed solution for water demineralization application was prepared as follows.

A synthetic feed solution of 1000 L was prepared by dissolving accurately weighed quantities of 87.5 g of sodium chloride, 35.5 g of sodium sulphate, 49.5 g of sodium metasilicate (100% pure basis) and 10.1 g of sodium bicarbonate. Each salt was dissolved and diluted to about 10 L in a polyethylene container. All these salt solutions were further gently added to synthetic feed water tank and diluted to 1000 L with deionized water. The synthetic feed water quality parameters are tabulated in Table 13. This feed water first passed through the column of SAC (Cation) resin in H+ form to get the following water quality after ex-cation. This water to be checked for Na content for every 30 minutes during passing through the cation resin column as mentioned in above

### Experiment 55.

TABLE 13
The synthetic feed water quality parameters
for demineralization application

| Parameter | Concentration |
|---|---|
| EMA | 100 ppm as CaCO₃ |
| Chlorides | 75 ppm as CaCO₃ |
| Sulphates | 25 ppm as CaCO₃ |
| SiO2 | 27 ppm as CaCO₃ |
| Total alkalinity + SiO₂ Total Anions | 133 ppm as CaCO₃ |
| Methyl orange alkalinity | 6 ppm as CaCO₃ |
| % SiO₂/Total alkalinity | 20.3 |
| % SO₄/EMA | 25 |

Two glass columns were filled with 250 mL each resin from Example 52 and another one column with 250 mL of commercial resin comprising single component cross-linked copolymer in chloride form.

The feed solution prepared above was passed through the columns at a flow rate of 24 BV/hour in gravity flow mode. Water exiting column outlet was intermittently checked for silica content at every 30 minutes. The SiO₂ content analysis was conducted by HACH spectrophotometer DR2010 according to instrument specified Programme No 651.

The column operation was stopped when the concentration of silica (SiO₂) in column out let reached to 0.2 ppm. Total feed solution passed through the column was noted and OEC of the resin was calculated. First cycle was called conditioning cycle. Thereafter the resin was regenerated by passing 4% w/v sodium hydroxide solution through resin bed in co-current mode with 30 minutes contact time. The resin was then rinsed with deionized water to remove residual alkali from the resin bed. Three demineralization cycles were similarly conducted. The performance of the resin was evaluated at regeneration level of 60 g/L of 100% NaOH/L of resin (using 4% w/v NaOHsolution). The results are tabulated in Table 14.

TABLE 14
SBA resin - Comparative results at 60 g/L
regeneration level average of three cycles

| | Example 52 resin | Indion GS300 |
|---|---|---|
| Parameters | in Cl form | Cl form |
| TEC, g/L as CaCO₃• | 51.0 | 65.0 |
| OEC, g/L as CaCO₃• | 28.31 | 26 |
| OEC/TEC, % | 55.5 | 40.0 |
| Silica Leakage ppb as SiO₂• | 21 | 30 |
| Rinse water volume BV for | 1.5 | 2.0 |
| slow rinse (pH < 9.5) | | |

| | |
|---|---|
| Remarks | Higher Regeneration efficiency at |
| | lower TEC level. |

### Example 58

The weak acid cation exchange (WAC) resin product obtained in the Examples 53 and 54 were evaluated for their performance for de-alkalization of water application. The procedure followed was as per ASTM.Designation: D 2187-94 (Reapproved 2004). The columns used for the experiment is shown in the FIG. 2.

A synthetic feed solution of 1000 L was prepared by dissolving accurately weighed quantities of 185.0 g of calcium hydroxide (about 80% pure) in 200 L of deionized water dissolved it by purging CO₂ gas in water. The CO₂ gas to be purged till entire calcium hydroxide is dissolved in 200 L water. This water is further diluted to 1000 L in feed water tank using deionized water to get the following water quality. The feed water quality is tabulated in Table 15.

TABLE 15
The synthetic feed water quality parameters
for demineralization application

| Parameter | Concentration |
|---|---|
| M. Alkalinity | 200 ppm as CaCO₃ |
| Total Hardness | 200 ppm as CaCO₃ |
| Calcium hardness | 200 ppm as CaCO₃ |
| Total Cations | 200 ppm as CaCO₃ |

Three glass columns were filled with 250 mL of each of weak acid cation resin (Examples 53 and Example 54) and another third column with 250 mL of commercial resin (Indion 236) comprising single component cross-linked copolymer.

The feed solution prepared above was passed through the columns at a flow rate of 20 BV/hour in gravity flow mode. The treated water exiting from column outlet was tested for alkalinity content at 30 minutes intervals. The alkalinity test was based on acid-base titration using phenolphthalein and methyl orange as indicators.

The experiment was stopped, when the concentration of methyl orange alkalinity in column outlet as CaCO₃ reached to 5.0 ppm. Total feed solution passed through the column was noted and operating exchange capacity of the weak acid cation exchange resin was calculated as the below formula

$$O E C = \frac{( Feed alkalinity as C a C {O}_{3} ) \times ( Total output in Liter )}{Resin volume in Liter \times 1000}$$

First cycle was called conditioning run. After this conditioning run, the resin was regenerated by passing 5% w/v HCl solution through resin bed in co-current mode. The contact time was 45 minutes. The resin was then rinsed with deionized water to remove residual acid from resin bed. Three further cycles of de-alkalization were similarly conducted.

The performance of the resin was evaluated at regeneration level of 115% of work done (considering about 85% regeneration efficiency of WAC resin with HCl against the work done) by the resin using 5% w/v HCl solution. The results are tabulated in Table 16.

TABLE 16
WAC resin application in water de-alkalization application

| Parameter | Example 53 | Example 54 | Indion 236 H |
|---|---|---|---|
| TEC, g/L as CaCO₃• | 138.0 | 97.5 | 210.0 |
| OEC, g/L as CaCO₃• | 68.34 | 58.13 | 102.26 |
| OEC/TEC, % | 49.52 | 59.62 | 48.69 |
| Average leakage ofmethyl | <1.0 | <1.0 | <1.0 |
| orange alkalinity, ppm as | | | |
| CaCO₃• | | | |
| Rinse water volume BV for | 1.5 | 1.5 | 2 |
| slow rinse (pH > 4.5) | | | |

| | |
|---|---|
| Remarks | Higher Regeneration efficiency at |
| | lower TEC level. |

### Example 59 X-Ray Microtomography Imaging

X-ray microtomography imaging of two component crosslinked polymer beads and the ion exchange resins synthesized there from was carried out as per the details given below.

### Instrument Details:

Model & Make: X radia Versa 510, Carl Zeiss, USA.

X-ray Source: 160 kV high energy micro-focus sealed X-ray tube.

Detector: 2 k×2 k high resolution 16-bit CCD digital camera assembly with in-line optical magnifiers

### Parameters & Methodology:

X-ray Power (kV/W): 60/5, Objective: 4×, Field of View (FOV): 3.1 mm, Exposure Time: 1 see, Filter: Nil, Cone angle: 7.48 Deg, Voxel Size: 3.1 microns, Projections: 3201, Scan Time: 3 hours 16 mins

### IV. Software's for Imaging and Processing:

Image Acquisition: Scout-and-Scan Control System, Version 11.1.8043.19515 (Carl Zeiss, USA)

Image Processing: Dragonfly Pro, Version 3.6.1.492 (Object Research Systems Inc, Canada).

### Imaging Protocol:

Samples were loaded on to micro-pipette tips, sealed and placed on a sample holder. Sample holder is kept in between X-ray source and detector. Imaging parameters were optimized to attain X-ray projections of the sample with significant contrast using Scout-and-Scan Control System software.

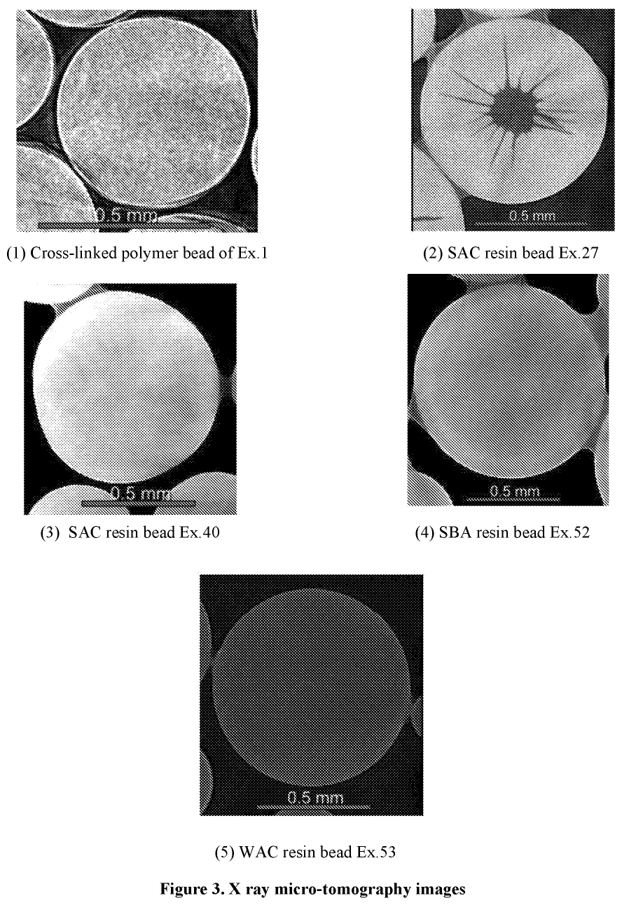

Optimized imaging parameters were given above and kept constant for all fivesamples. X-ray energy of 60 kV was used during the imaging process. 3201 X-ray projection images were captured per sample with 1 see X-ray exposure per projection. Objective lens with 4× magnification was employed to attain a pixel size of 3.1 microns. 2D virtual cross-sections of sample were generated from the X-ray projections, based on a reconstruction algorithm1. Time required for imaging process was approximately 3 hours per sample, followed by 1 hour post-processing of images using Dragonfly Pro software package. Normalization of the attenuation histogram, filtration of images and diameter measurement were performed during the post-processing stage The images presented in FIG. 3 illustrate that the two component crosslinked polymer beads of Example 1 and the strong acid cation exchange resin of Example 40, strong base anion exchange resin of Example 52 and weak acid cation exchange resin of Example 53 exhibit uniform absorption contrast indicating lack of core shell morphology whereas the strong acid cation exchange resin of Example 27, exhibits lower absorption contrast in its core indicating presence of core shell morphology.

1. A two component cross-linked copolymer composition in bead form comprising the cross-linked copolymer of the first component formed in the first step having lower cross-linker content than the cross-linker content in the cross-linked copolymer of the second component incorporated in the second step, wherein the said composition exhibits a single stage swelling behaviour in solvent.

2. A two component cross-linked copolymer composition in bead form as claimed in claim 1 wherein the said composition exhibits a single stage swelling behaviour in the solvent which is toluene.

3. A two component cross-linked copolymer composition in bead form as claimed in claim 2 wherein the maximum swelling is reached in 0.75 to 24 hrs.

4. A two component cross-linked copolymer composition in bead form as claimed in claim 1 wherein the weight ratio of the cross linked copolymer of the first component to that of the cross linked copolymer of the second component is in the range 1:1.2 to 1:2.64.

5. A two component cross-linked copolymer composition in bead form as claimed in claim 1 wherein the monovinyl monomer of the cross-linked copolymer of the first component is selected from styrene, methyl methacrylate, methyl acrylate and methacrylic acid.

6. A two component cross-linked copolymer composition in bead form as claimed in claim 1 wherein the monovinyl monomer of the cross-linked copolymer of the second component is selected from styrene, methyl methacrylate, methyl acrylate, methacrylic acid, hydroxy propyl acrylate and hydroxy ethyl methacrylate.

7. A two component cross-linked copolymer composition in bead form as claimed in claim 1 wherein the cross-linker content of the cross-linked copolymer of the first component is in the range of 1.8 to 3% w/w.

8. A two component cross-linked copolymer composition in bead form as claimed in claim 1 wherein the cross-linker content of the cross-linked copolymer of the second component is in the range of 2 to 9% w/w.

9. A two component cross-linked copolymer composition in bead form as claimed in claim 1 wherein the cross-linker in the cross-linked copolymer of the first component is selected from divinyl benzene (DVB), ethylene glycol dimethacrylate (EGDMA), 1, 7-octadiene, trivinyl cyclohexane (TVCH).

10. A two component cross-linked copolymer composition in bead form as claimed in claim 1 wherein the cross-linker in the cross-linked copolymer of the second component is selected from divinyl benzene (DVB), ethylene glycol dimethacrylate (EGDMA), 1, 7-octadiene, trivinyl cyclohexane (TVCH).

11. A two component cross-linked copolymer composition in bead form as claimed in claim 1 wherein the bead size is in the range of 250 to 800 μm.

12. A process for the synthesis of two component cross-linked copolymer composition in bead form as claimed in claim 1 comprising the steps of adding to the reactor a weighed amount of water, a protective colloid and a stabilizer, raising the temperature to about 75° C. while stirring in the range of 200 and 300 rpm, adjusting the stirring in the range of 60 and 70 rpm, adding the monomer composition constituting the cross-linked copolymer of the of the first component, maintaining the temperature at 75° C., maintaining the stirring speed between 100 and 120 rpm when the reaction mass becomes sticky, continuing the polymerization for about 3 hours, raising the temperature to 85° C. and continuing polymerization for about 3 hours, then raising the temperature to 95° C. and continuing polymerization for about 3 hours, cooling the reaction mass to room temperature, separating out the aqueous medium, adding to the cross-linked copolymer of the of the first component formed, the monomer composition constituting the cross-linked copolymer of the of the second component, imbibing the cross-linked copolymer of the first component formed with the monomer composition constituting the cross-linked copolymer of the second component, over a period of about 2 hours, adding fresh aqueous solution containing the protective colloid and the stabilizer, stirring the reaction mass between 100 and 120 rpm, continuing the polymerization at 75° C., for about 3 hours, raising the temperature to 85° C. continuing polymerization for about 3 hours, raising the temperature to 95° C. continuing polymerization for about 3 hours, cooling the reaction mass to room temperature, washing the two component cross-linked copolymer beads with water until the wash water showed no foaming, and drying the recovered beads in a hot air oven at 100° C. for 8 hours.

13. A process as claimed in claim 12 wherein the protective colloid is selected from hydroxy propyl methyl cellulose, hydroxy propyl ethyl cellulose, and PVA.

14. A process as claimed in claim 12 wherein the concentration of protective colloid in water is between 0.08 to 0.4% w/w.

15. A process as claimed in claim 12 wherein the stabilizer is selected from monosodium phosphate, di sodium phosphate and tri sodium phosphate.

16. A process as claimed in claim 12 wherein the stabilizer concentration in water is about 0.5 to 0.82% w/w.

17. A process as claimed in claim 12 wherein the monomer constituting the cross-linked copolymer of the first component is selected from styrene, methyl methacrylate, methyl acrylate and methacrylic acid.

18. A process as claimed in claim 12 wherein the monomer constituting the cross-linked copolymer of the second component is selected from styrene, methyl methacrylate, methyl acrylate, methacrylic acid and hydroxy ethyl methacrylate.

19. A process as claimed in claim 12 wherein the cross-linker constituting the cross-linked copolymer of the first component is selected from divinyl benzene (DVB), ethylene glycol dimethacrylate (EGDMA), 1,7-octadiene and trivinyl cyclohexane (TVCH).

20. A process as claimed in claim 12 wherein the cross-linker constituting the cross-linked copolymer of the second component is selected from divinyl benzene (DVB), ethylene glycol dimethacrylate (EGDMA), 1,7-octadiene and trivinyl cyclohexane (TVCH).

21. A process as claimed in claim 12 wherein the cross-linker content of the cross-linked copolymer of the first component is in the range of 1.8 to 3% w/w.

22. A process as claimed in claim 12 wherein the cross-linker content of the cross-linked copolymer of the second component is in the range of 2 to 9% w/w.

23. An ion exchange resin in bead form comprising a two component cross-linked copolymer composition as claimed in claim 1 wherein the said ion exchange resin exhibits a ratio of operating exchange capacity (OEC) to total exchange capacity (TEC) in the range of 49 to 61%.

24. An ion exchange resin as claimed in claim 23 wherein the said ion exchange resin is a strong acid cation exchange resin.

25. A strong acid cation exchange resin, as claimed in claim 24 wherein the said strong acid cation exchange resin has a total exchange capacity in the wet form in the range of 1.25 to 1.85 eq/L

26. A strong acid cation exchange resin, as claimed in claim 24 wherein the said strong acid cation exchange resin has an OEC/TEC ratio in the range of 49% to 61% at 50 g/L regeneration level.

27. A strong acid cation exchange resin as claimed in claim 24 wherein the said strong acid cation exchange resin has a crushing strength in the range of 500 g to 1000 g/bead.

28. A strong acid cation exchange resin, as claimed in claim 24 wherein the said strong acid cation exchange resin when subjected to osmotic shock resistance test retains a whole bead count greater than 85%.

29. A process for the synthesis of a strong acid cation exchange resin, as claimed in claim 24 comprising the steps of charging the two component cross-linked copolymer composition to the reactor, adding concentrated sulfuric acid to the reactor, stirring the contents of the reactor at 200 rpm, heating the reaction mass to 110±2° C. and continuing the reaction for the desired time by observing the progress of reaction under microscope, cooling the reaction mass, draining off the sulfuric acid, subjecting the reaction product to programmed hydration using sulfuric acid aliquots of decreasing sulfuric acid concentration, washing the reaction product with deionised water till the washings are free from acid and recovering the product by decanting off excess water.

30. A process for the synthesis of a strong acid cation exchange resin as claimed in claim 29 wherein the ratio of two component cross-linked copolymer composition to sulfuric acid is in the range of 1:3.6 to 1:10.8 w/w.

31. A process for the synthesis of a strong acid cation exchange resin as claimed in claim 29 wherein the concentration of sulfuric acid is 93-100% w/w.

32. A process for the synthesis of a strong acid cation exchange resin as claimed in claim 29 wherein the reaction time is 2 to 6 hours.

33. A process for the synthesis of a strong acid cation exchange resin as claimed in claim 29 wherein programmed hydration using sulfuric acid involves stirring the reaction product for 30 to 45 minutes, with 250 mL aliquots of sulfuric acid solution in water of sulfuric acid concentration 85%, 78%, 65%, 45%, 30%, 25% and 15% w/w.

34. An ion exchange resin as claimed in claim 23 wherein the said ion exchange resin is a strong base anion exchange resin.

35. A strong base anion exchange resin, as claimed in claim 34 wherein the said strong base anion exchange resin has a total exchange capacity in the wet form is in the range of 0.74 and 1.02 eq/L

36. A strong base anion exchange resin, as claimed in claim 34 wherein the said strong base anion exchange resin has OEC/TEC ratio in the range of 55 to 57%

37. A strong base anion exchange resin, as claimed in claim 34 wherein the said strong base anion exchange resin has a crushing strength in the range of 300 g to 600 g/bead.

38. A strong base anion exchange resin, as claimed in claim 34 wherein the said strong base anion exchange resin when subjected to osmotic shock resistance test retain a whole bead count greater than 85%.

39. A process for the synthesis of a strong base anion exchange resin as claimed in claim 34 comprising the steps of charging into the reactor methanol-formaldehyde solution, methanol, methylal, water and ferric chloride, adding chlorosulfonic acid over a period of 5-6 hours maintaining the reaction temperature at 38-40° C., charging the two component cross-linked copolymer composition as claimed in claim 1 into the reactor, at around 20° C. continuing the reaction at 38-40° C. for 5-6 hours, cooling the reaction mass below 20° C., quenching the reaction by washing the reaction mass with three aliquots of 300 mL methanol, washing with dilute aqueous sodium hydroxide solution and then water till the pH of washings is neutral, charging the chloromethylated resin to the reactor containing water, draining out water and swelling the resin with methylal, leaving excess methylal in the reactor, adjusting the pH to 10-12 by adding aqueous sodium hydroxide, adding 30% aqueous trimethyl amine over a period of 30-45 minutes, stirring at 25-30° C. for 30 minutes, raising the temperature to 42-45° C., maintaining for 6 hours, recovering methylal by heating up to 80° C., cooling the reaction mass to room temperature and adding 50 mL of 7% hydrochloric acid, stirring for half an hour, filtering the reaction mass and washing with demineralized water till the washings free from acid and recovering the product by filtration.

40. A process for the synthesis of a strong base anion exchange resin, as claimed in claim 39 wherein the ratio of two component cross-linked copolymer composition to chloromethylating agent is in the range of 0.94 to 2.25 w/w.

41. An ion exchange resin as claimed in claim 23 wherein the said ion exchange resin is a weak acid cation exchange resin.

42. A weak acid cation exchange resin as claimed in claim 41, has a total exchange capacity of 1.95 to 2.76 eq/L.

43. A process for the synthesis of weak acid cation exchange resin as claimed in claim 41 comprising charging into reactor water, adding protective colloid followed by sodium chloride, stirring the mixture at 200-300 rpm, adjusting the stirrer speed to 60-70 rpm, charging into the reactor the monomer composition constituting the cross-linked copolymer of the first component, raising the temperature to 65° C.,
increasing the stirring speed to 100-120 rpm after 40-45 minutes, continuing the polymerization at 65° C. for three hours, followed by continuing polymerization at 75° C. for three hours, followed by continuing polymerization at 85° C. for three hours, and finally at 95° C. for three hours, washing the reaction product with deionized water till the washings are free from surfactant as evidenced by absence of foaming in the washings and drying the product at 100° C. for 8 hours, imbibing the cross-linked copolymer of the of the first component, with the monomer composition constituting the cross-linked copolymer of the of the second component for about two hours, charging the aqueous phase containing the protective colloid and sodium chloride into the reactor, stirring the reaction mass at 100-120 rpm, and polymerizing the reaction mass at 65° C. for three hours, followed by continuing polymerization at 75° C. for three hours, followed by continuing polymerization at 85° C. for two hours, adding caustic lye to thereactor and continuing heating at 85° C. for three hours and finally at 95° C. for three hours, cooling the reaction mass to room temperature and washing with demineralized water.

44. A process for the synthesis of weak acid cation exchange resin as claimed in claim 43 wherein the protective colloid is selected from hydroxy ethyl cellulose, carboxy methylcellulose, and sodium lignosulfonate.

45. A process for the synthesis of weak acid cation exchange resin as claimed in claim 43 wherein the composition constituting the cross-linked copolymer of the first component comprises monomers selected from methyl acrylate and methacrylic acid.

46. A process for the synthesis of weak acid cation exchange resin as claimed in claim 43 wherein the composition constituting the cross-linked copolymer of the second component comprises monomers selected from methyl methacrylate, methyl acrylate and methacrylic acid and hydroxy ethyl methacrylate.

47. A process for the synthesis of weak acid cation exchange resin as claimed in claim 43 wherein the composition constituting the cross-linked copolymer of the first component comprises cross-linkers selected from divinyl benzene (DVB), ethylene glycol dimethacrylate (EGDMA), 1,7-octadiene, trivinyl cyclohexane (TVCH).

48. A process for the synthesis of weak acid cation exchange resin as claimed in claim 43 wherein the composition constituting the cross-linked copolymer of the of the second component comprises cross-linkers selected from divinyl benzene (DVB), ethylene glycol dimethacrylate (EGDMA), 1,7-octadiene, trivinyl cyclohexane (TVCH).
